(19) United States
(12) Patent Application Publication
(10) Pub. No.: US 2014/0193673 A1
(43) Pub. Date: Jul. 10, 2014

(54) POLARITY SWITCHING FLOW BATTERY SYSTEM AND METHOD

(71) Applicant: Ashlawn Energy, LLC, Alexandria, VA (US)

(72) Inventors: Michael Woolery, Hot Springs, AR (US); Joseph F. Startari, South Euclid, OH (US); Maurice Daniel, Alexandria, VA (US); Bryan P. Tipton, Johnstown, PA (US)

(73) Assignee: Ashlawn Energy, LLC, Alexandria, VA (US)

(21) Appl. No.: 14/147,516

(22) Filed: Jan. 4, 2014

Related U.S. Application Data
(60) Provisional application No. 61/848,455, filed on Jan. 4, 2013.

(51) Int. Cl. H01M 8/04; H01M 8/20; H01M 8/18

(52) U.S. Cl. CPC H01M 8/04186; H01M 8/188; H01M 8/20
USPC 429/51; 429/105; 429/64

(57) ABSTRACT

A flow battery system and method are provided. The flow battery system may include a feed system feeding positive electrolyte from a first storage tank to a positive inlet of a battery stack and negative electrolyte from a second storage tank to a negative inlet of the battery stack, a return system returning charged electrolyte from the battery stack to the first and second storage tanks, and a controller to selectively control at least one of the feed system and the return system so positive electrolyte, from the first storage tank, is applied a negative charge by the battery stack and then returned by the return system to the second storage tank, and so negative electrolyte, from the second storage tank, is applied a positive charge by the battery stack and then returned by the return system to the first storage tank.

### CROSS-REFERENCE TO RELATED APPLICATIONS

This application claims the benefit of U.S. Provisional Application No. 61/848,455, filed Jan. 4, 2013, in the United States Patent and Trademark Office, the disclosure of which is incorporated herein by reference.

### BACKGROUND

1. Field

One or more embodiments relate to a polarity switching flow battery system and method, and more particularly, to a flow battery system and method that performs a polarity switching operation while charging the electrolyte the flow battery system for rebalancing the flow battery system.

2. Description of the Related Art

Reduction-oxidation (redox) flow batteries, also known as regenerative fuel cells, or reversible fuel cells, or secondary fuel cells, are a type of storage battery having two liquid electrolytes; a positive electrolyte or catholyte, and a negative electrolyte or anolyte.

The two electrolytes are typically separated from one another by an ion exchange membrane. In this type of battery the two electrodes are typically inert and primarily serve to collect or distribute the electric charge from the battery cell(s). The membrane may divide the battery into two half-cells, for example. Here, each half-cell may generally be made up of a rectangular frame with a central rectangular cavity, with the membrane being stretched across one side of the frame and a conductive graphite plate serving as the electrode and extending across the other side of the frame. In such an arrangement, a rectangle of electrically conductive carbon felt may be cut to fit inside and fill the entire cavity of the half-cell to assist in collecting or distributing electric charge from the electrolyte. Positive electrolyte would fill the positive half-cell and negative electrolyte would fill the negative half-cell within the carbon felt. Both electrolytes are usually metal salts in an acid solution. For example in an iron/chrome couple redox flow battery the negative electrolyte contains iron ions and the positive electrolyte contains chromium ions, both dissolved in a hydrochloric acid solution. In a flow battery the positive and negative electrolyte solutions are stored in tanks external to the battery and pumps are typically used to feed the electrolytes through their respective half-cells during charging and discharging periods of operation.

In a conventional redox battery system the electrolytes may be drawn out of their respective storage tanks by such pumps and injected into the bottom of the battery stack. If the battery stacks are placed above the storage tanks the electrolyte emerging from the top of the battery stack may be allowed to drain by gravity back into the storage tanks; otherwise the electrolyte may be pumped back into the storage tanks.

FIG. 1 illustrates a redox flow battery system 150 with a battery stack 105 elevated above storage tanks 101L and 101R. In this two-tank arrangement, positive electrolyte 130L is stored in storage tank 101L and negative electrolyte 130R is stored in the storage tank 101R. Electrolyte is respectively drawn out of the bottom of storage tanks 101L and 101R by the action of feed pumps 103L and 103R. Electrolyte is usually then forced through the bottom of the battery stack 105 and out the top of the battery stack 105. After exiting battery stack 105, the electrolyte respectively flows through pipes 106L and 106R into the top of the storage tanks 101L and 101R where it is then sprayed, or dripped, onto the top of the electrolyte contained in the tank. This spraying of electrolyte into the storage tanks 101L and 101R prevents an electrical circuit from being formed in the fluid loop thus reducing shunt current losses. An inert gas 135, such as nitrogen or argon, may be maintained at the top of the storage tanks 101L and 101R to prevent oxidation of the reactants. Some sort of snorkel mechanisms 110L and 110R may be respectively placed at the top of the storage tanks 101L and 101R to allow equalization of the pressure of gas 135 inside the storage tanks 101L and 101R to the ambient air outside the storage tanks 101L and 101R.

The big advantage of all redox flow batteries is that the electrical energy may be stored entirely in the electrolytes, as opposed to other types of secondary batteries, such as lead-acid car batteries, that store energy on the surface of their electrodes. The power (watts or megawatts) that a flow battery can output is determined by the amount of surface area of its aforementioned battery cell membranes, which in turn may be a determining factor regarding the overall size of the corresponding battery stack. The amount of power (watt-hours or megawatt-hours) that a flow battery can provide is determined by its quantity of electrolyte, which in turn determines the size of the storage tanks needed to store the electrolyte. Accordingly, the size of the battery stack(s) of a flow battery system define the megawatts that the flow battery system can provide and the size of the electrolyte storage tanks of the flow battery system define the number of hours the battery can provide its rated power. This feature of flow batteries allows them to be tailor made to the requirements of a large facility, such as a solar array or wind farm.

Flow batteries typically require the use of pumps to distribute the two electrolytes from their respective storage tanks, through the battery stack between the electrodes and membranes, and back to their respective storage tanks thus forming a hydraulic circuit. This electrolyte flow is maintained during both the charge and discharge of the flow battery. Generally the pumps are electric powered and consume a portion of the battery's source of electricity, thus reducing the battery's over-all efficiency. Flow batteries' potential reliance on pumps makes them less suitable for small applications.

As demonstrated above, flow batteries use a positive and a negative electrolyte separated by a semi-permeable ion exchange membrane. These membranes may be a cation exchange membrane (the most common type) which only allows the exchange of positively charged ions (cations); or the membranes may be a anion exchange membrane which only allows the exchange of negatively charged ion (anions) There are also neutral or reversible membranes that can allow ion flow in either direction.

Of particular interest are the all-vanadium redox flow batteries (VRFBs). In this type of flow battery the positive electrolyte contains VO2+ ions which undergo a reduction reaction to VO2+ plus electricity during its discharge cycle. The opposite oxidation reaction takes place during the charging of the battery, where VO2+ ion plus electricity are transformed back to VO2+ ions. In the negative electrolyte V2+ ions undergo an oxidation reaction to yield V3+ ions plus electricity during its discharge cycle. During the charging cycle V3+ ions plus electricity in the negative electrolyte is reduced back to V2+ ions. Herein, these four vanadium valence states will be written as V(5), V(4), V(3), and V(2). The charge/discharge states in the positive electrolyte is represented as V(5)/V(4) and the charge/discharge states in the negative electrolyte will be represented as V(2)N(3).

The great advantage of the VRFB is that both the positive and negative electrolytes consist of a mix of vanadium ions, sulfuric acid, and water. Since membranes are generally imperfect and allow some electrolyte to pass through to the opposite half-cell, no serious harm is done to the chemistry of the battery. The cross-over ions simply have a higher or low valence state then the surrounding ions. Normal flow battery action will eventually bump their valence states back up to the normal surrounding electrolyte range. This self-correcting of the valence states of cross-over ions will require added electrical energy, but if the leakage across the membrane is small this will have a negligible effect on battery efficiency.

A net flow of water occurs across the membrane during normal operation of a VRFB, for example. If a cation membrane is used (the more common membrane type) the net water flow is from the negative side to the positive side. The opposite is true if anion membranes are used. Approximately 75% of water transfer is due to osmotic action and the remainder is due to vanadium ion transfer. Osmotic flow occurs even though the concentrations of reactants are the same on both sides the membrane, the various vanadium ions are of different sizes which creates an osmotic difference. Vanadium ion transfer is caused by leakage of vanadium ions through the membrane. Each vanadium ion is surrounded by a number of water molecules which tag-along with the ion through the membrane. The amount of water transfer by these processes varies by the particular membrane used, by state of charge (SOC), and other factors. Water transfer can even reverse direction through the membrane depending on the SOC. On average, with a cation membrane, water transfer causes the positive electrolyte, e.g., stored in storage tank 101L of FIG. 1, to increase in volume and become diluted while the negative electrolyte, e.g., stored in storage tank 101R of FIG. 1, loses volume and becomes more concentrated.

A commonly accepted practice to address this water transfer, causing an imbalance in the flow battery, is to periodically balance the two electrolytes by transferring the excess positive electrolyte into the anode tank, i.e., transfer the excess positive electrolyte in storage tank 101L into storage tank 101R. This procedure restores the two storage tanks back to their original volumes. This procedure is possible in a VRFB, for example, where the chemical composition of the two electrolytes is the same. The rebalancing procedure may be performed during a period when the VRFB is in a low state of charge. Any charge remaining in the catholyte solution at the time of transfer cancels out an equal amount of charge in the anolyte solution and is thereby lost to productive use. The procedure of periodically rebalancing the electrolyte tanks for water transfer can alternatively be performed continuously by installing an overflow pipe between the cathode and anode storage tanks, such as the pipe 112 of FIG. 1, discussed below. This will cause a few percent loss in battery efficiency per day, but solves the water transfer problem in the short term.

Another method of dealing with unbalanced excess water accumulation between the electrolyte storage tanks is to maintain one electrolyte storage tank higher then the other, as described in U.S. Pat. No. 6,764,789, incorporated herein by reference. The higher storage tank will produce a higher gravitational head pressure in the positive electrolyte feed line at the positive electrolyte inlet of the battery stack than produced in the negative electrolyte feed line at the negative electrolyte inlet of the battery stack by the lower storage tank. Here, this difference in produced gravitational head pressures is reflected within each battery cell, across the membrane in each battery cell. Accordingly, this difference in gravitational head pressure can exactly counter the reverse flow the water migration, migration pressure, across the migration. One disadvantage of this method is that the water migration pressure changes with temperature, outside pressure, and ion concentration, and state of charge (SOC), thus adding the requirement that the relative tank heights be adjustable. Also the height differential requirement may be quite high thus adding to the battery height and related building requirements. Another problem is that the gravity head pressure differential between the two electrolyte storage tanks exists at the membrane, because this is the only place where the two electrolytes interact with each other. This places considerable strain on the membrane and associated seals, which will likely eventually cause them to rupture.

As also described in U.S. Pat. No. 6,764,789, such as for use in the configuration of the flow battery system 150 of FIG. 1, when both positive and negative electrolyte solutions of the flow battery are vanadium based, the electrolyte may be an aqueous solution of a vanadium salt such as vanadium sulfate and vanadyl sulfate in sulfuric acid with a vanadium ion concentration in this aqueous solution of its indicated 0.5 mol/l to 8 mol/l. U.S. Pat. No. 6,764,789 provides examples of its preferred vanadium electrolyte solutions, including its vanadium concentration of 0.6 mol/l to 6.0 mol/l, its more preferred 0.8 mol/l to 5.0 mol/l, its even more preferred 1.0 mol/l to 4.5 mol/l, its especially preferred 1.2 mol/l to 4.0 mol/l, and its most preferred 1.5 mol/l to 3.5 mol/l. As also explained in U.S. Pat. No. 6,764,789, when the vanadium concentration is below its indicated 0.5 mol/l, the energy density of the resulting battery is low and, when the vanadium concentration is above its indicated 8.0 mol/l, the electrolyte has a higher viscosity, which increases the resistance of the battery cell and decreases the energy efficiency.

In another example, U.S. Pat. No. 6,764,789, such as for use in the configuration of the flow battery system 150 of FIG. 1, recommends its preferred concentrations of an aqueous solution of a vanadium salt in sulfuric acid as the electrolyte, with the concentration of sulfate ions being its preferred 0.5 mol/l to 9.0 mol/l, its more preferred 0.8 mol/l to 8.5 mol/l, its even more preferred 1.0 mol/l to 8.0 mol/l, its especially preferred 1.2 mol/l to 7.0 mol/l, and its most preferred 1.5 mol/l to 6.0 mol/l. U.S. Pat. No. 6,764,789 also provides examples of its preferred ion exchange equivalents for the anion and cation exchange group layers, as well as its preferred mixtures of tetravalent or pentavalent vanadium ions in the positive electrolyte in a charged state of the flow battery, with its preferred concentration of pentavalent vanadium ions at the completion of its charge being 0.5 mol/l to 7.5 mol/l, its preferred 0.6 mol/l to 5.5 mol/l, its more preferred 0.8 mol/l to 4.5 mol/l, its even more preferred 1.0 mol/l to 4.0 mol/l, its especially preferred 1.2 mol/l to 3.8 mol/l, and its most preferred 1.5 mol/l to 3.5 mol/l. As also explained in U.S. Pat. No. 6,764,789, a ratio of pentavalent vanadium ions to the concentration of all the vanadium ions in the positive electrolyte at the completion of charge may also be its preferred 50% or more and 100% or less, its more preferred 60% or more and 99% or less, its even more preferred 65% or more and 98% or less, its especially preferred of 70% or more and 97% or less, and its most preferred 75% or more and 96% or less.

Although the positive electrolyte can contain a mixture of tetravalent and pentavalent vanadium ions, tetravalent vanadium ions alone, or a mixture of tetravalent and trivalent vanadium ions in a discharged state in the flow battery, a concentration of tetravalent vanadium ions in the positive electrolyte at the completion of discharge may be its indicated 0.5 mol/l to 7.5 mol/l, its preferred 0.6 mol/l to 5.5 mol/l, its more preferred 0.8 mol/l to 4.5 mol/l, its even more preferred 1.0 mol/l to 4.0 mol/l, its especially preferred 1.2 mol/l to 3.8 mol/l, and its most preferred 1.5 mol/l to 3.5 mol/l. As also explained in U.S. Pat. No. 6,764,789, a ratio of tetravalent vanadium ions to the concentration of all the vanadium ions in the positive electrolyte at the completion of discharge may be its preferred 50% or more and 100% or less, its more preferred 60% or more and 99% or less, its even more preferred 65% or more and 98% or less, its especially preferred of 70% or more and 97% or less, and its most preferred 75% or more and 96% or less. Furthermore, a ratio of trivalent vanadium ions to the concentration of all the vanadium ions in the positive electrolyte at the completion of discharge may be its preferred 30% or less, its more preferred 25% or less, its even more preferred 20% or less, its especially preferred of 10% or less, and its most preferred of 5% or less.

In addition, as also explained in U.S. Pat. No. 6,764,789, although the negative electrolyte may contain a mixture of trivalent and divalent vanadium ions or divalent vanadium ions alone in a charged state in the flow battery, the concentration of divalent vanadium ions in the negative electrolyte at the completion of charge may be its indicated 0.5 mol/l to 7.5 mol/l, its preferred 0.6 mol/l to 5.5 mol/l, its more preferred 0.8 mol/l to 4.5 mol/l, its even more preferred 1.0 mol/l to 4.0 mol/l, its especially preferred 1.2 mol/l to 3.8 mol/l, and its most preferred 1.5 mol/l to 3.5 mol/l. As also explained in U.S. Pat. No. 6,764,789, a ratio of divalent vanadium ions to the concentration of all the vanadium ions in the negative electrolyte at the completion of charge may be its preferred 50% or more and 100% or less, its more preferred 60% or more and 99% or less, its even more preferred 65% or more and 98% or less, its especially preferred of 70% or more and 97% or less, and its most preferred 75% or more and 96% or less. As also explained in U.S. Pat. No. 6,764,789, although the negative electrolyte can contain a mixture of trivalent and divalent vanadium ions, divalent vanadium ions alone, or a mixture of tetravalent and trivalent vanadium ions in a discharged state in the flow battery, a concentration of trivalent vanadium ions in the negative electrolyte at the completion of discharge may be its indicated 0.5 mol/l to 7.5 mol/l, its preferred 0.6 mol/l to 5.5 mol/l, its more preferred 0.8 mol/l to 4.5 mol/l, its even more preferred 1.0 mol/l to 4.0 mol/l, its especially preferred 1.2 mol/l to 3.8 mol/l, and its most preferred 1.5 mol/l to 3.5 mol/l. A ratio of trivalent vanadium ions to the concentration of all the vanadium ions in the negative electrolyte at the completion of discharge may be its preferred 50% or more and 100% or less, its more preferred 60% or more and its 99% or less, its even more preferred 65% or its more and 98% or less, its especially preferred of 70% or more and 97% or less, and its most preferred 75% or more and its 96% or less. As also explained in U.S. Pat. No. 6,764,789, a ratio of trivalent vanadium ions to the concentration of all the vanadium ions in the negative electrolyte at the completion of discharge may be its preferred 30% or less, its more preferred 25% or less, its even more preferred 20% or less, its especially preferred of 10% or less, and its most preferred of 5% or less.

Water transfer causes a secondary problem. The small flow of excess electrolyte into the negative electrolyte storage tank through the membranes (when cation membranes are used) causes an excess build-up of reactants on the negative side and a depletion of reactants on the positive side. This difference in reactant concentrations causes a loss in efficiency until eventually, at about 20% concentration difference, the flow battery becomes uneconomical to operate. A common solution to this problem is to “rebalance” the battery by completely mixing the two positive and negative electrolytes together and then restarting the flow battery. This procedure is possible because of the unique nature of the example vanadium battery, for example. After restarting, the battery operates for a number of cycles eventually bringing the reactants back to their recharged condition. However, this “brute force” method is expensive in terms of production time lost until the flow battery is again ready for use, and energy required to restore the valence states to their negative and positive charged states.

Accordingly, with further reference to FIG. 1, FIG. 1 illustrates the arrangement of a conventional flow battery when it is being charged. The positive side of the flow battery system 150, illustrated on the left (L), and the negative side of the flow battery system 150, illustrated on the right (R), are identical in arrangement and function. The two sides of the flow battery system 150 are therefore given the same initial reference numbers followed by an L or R reference indicator to indicate the component placement. During charging of the flow battery system 150, the positive electrolyte 130L, initially contained in the large storage tank 101L flows out the bottom of the tank through pipe line 102L by the action of the pump 103L. At this point, available for charging, electrolyte 130L may initially be considered ‘old discharged’ positive electrolyte. The pump 103L pushes the old discharged electrolyte through pipe line 104L and into the bottom of the elevated battery stack 105. After about three cycles through the battery stack 105 the previously exhausted (old discharged) positive electrolyte having a SOC of about 20% eventually becomes charged up to about 80% SOC. In each charging cycle, charged electrolyte emerges from the top of the battery stack 105, where it then flows through line 106L and into the top of the positive electrolyte tank 101L. The same process may take place on the negative/right side of the battery, where old discharged negative electrolyte becomes charged negative electrolyte after about three charging cycles through the battery stack 105. As charged electrolyte is returned to storage tanks 101L and 101R, the respective electrolytes 130L may be considered a mixture of new charged positive electrolyte being added to old positive electrolyte and the electrolyte 130R may be considered a mixture of new charged negative electrolyte added to old negative electrolyte.

The flow battery system 150 may receive its charge from alternating electric power (AC) taken from the grid, represented as power source 107. The electric power is passed through rectifiers 108L and 108R and into the two poles, or terminals, 109L and 109R of the battery stack 105. As illustrated, pole 109L is connected to positive battery half-cells of the battery stack 105 and pole 109R is connected to the negative battery half-cells of the battery stack 105. During normal battery charging current flows into the battery pole 109L and out of the pole 109R.

As noted above, during a normal charging of discharged electrolyte of the flow battery system 150, positive electrolyte from the bottom of the left tank 101L is passed through the positive side of an example battery cell of the battery stack 105, i.e., an example positive half-cell of the battery stack 105, to become positively charged electrolyte and is then returned to storage tank 101L. Likewise, on the right side of the flow battery system 150, depleted negative electrolyte is passed through the negative side of the example battery cell of the battery stack 105, i.e., an example negative half-cell of the battery stack 105, to become charged negative electrolyte and is then returned to storage tank 101R. It should be noted that when a VRFB, such as the flow battery system 150, is placed in a charge mode using a non-standard electrolyte containing a mixture of valence states, the input voltage/power may desirably be carefully regulated or the battery will likely overheat to destruction.

As noted above, in FIG. 1, the line 112 directly connects the tops of the electrolyte in the two tanks to compensate for water transfer. Again, in the conventional flow battery and depending on type of membrane, osmotic pressure may cause excess water to build up on the positive side of the battery. The conventional approach to this problem is to install this over-flow line 112 to allow this excess electrolyte to continuously flow back to the negative side of the battery. Actually, excess electrolyte may flow in either direction, depending on the SOC, but on average more electrolyte flows towards the negative tank 101R, which causes the negative tank to eventually acquire excess vanadium reactants.

Thus, when vanadium ion reactants become sufficiently unbalanced, the normal procedure is to completely mix together the two electrolytes in the two storage tanks 101L and 101R and then restart the flow battery system 150. This conventional electrolyte mixing process is illustrated in FIG. 2. Briefly, similar to FIG. 1, in the flow battery system 250 of FIG. 2, storage tanks 201L and 201R store respective electrolytes 230L and 230R, so that electrolyte is transported through lines 202L and 202R by pumps 203L and 203R toward battery stack 205 using lines 204L and 204R. After transporting through battery stack 205, electrolyte is respectively returned to storage tanks 201L and 201R through lines 206L and 206R.

As further illustrated in FIG. 2, to accomplish mixing of the electrolytes three-port valves 220L and 220R have been inserted between the pumps 203L and 203R and the battery stack 205. The valves 220L and 220R are controlled by controllers 221L and 221R. To accomplish the mixing, the flow battery system 250 is turned off and valves 220L and 220R are set to divert the flow of electrolyte from the battery stack 205 to the opposite storage tank respectively through lines 222L and 222R. That is, electrolyte from storage tank 201L is diverted by valve 220L into the negative tank 201R, rather than proceeding to the bottom of battery stack 205. Similarly, electrolyte from the storage tank 201R is diverted by valve 220R into the storage tank 201L, rather than proceeding to the bottom of battery stack 205. This mixing process continues until the two storage tanks 201L and 201R have approximately equal mixes of positive and negative electrolyte and the electrolytes have been thoroughly mixed together. As only an example, three passes or cycles of electrolyte flow may be needed to mix the electrolytes if mechanical mixers are not also used. Preferably mechanical mixers are also used. Meanwhile, during this mixing process, the flow battery system 250 is off-line. After charged electrolyte is returned to storage tanks 201L and 201R and the mixing process is begun, the respective electrolytes 230L may be considered a mixture of recently charged positive electrolyte, plus old positive electrolyte, plus old negative electrolyte and electrolyte 230R may be considered a mixture of recently charged negative electrolyte, plus old negative electrolyte, plus old positive electrolyte.

After the electrolytes have been mixed together, the valves 220L and 220R are returned to their normal positions to allow electrolytes from storage tanks 201L and 201R to respectively pass into the battery stack 205. The battery stack 205 may then be made to operate in its normal charging mode, using negative battery terminal 209R, the power source 207, and the diode inverters 208L and 208R operating in their normal charging mode to supply current to positive battery terminal 209L. However, the electrolyte being supplied to both sides, i.e., to respective half-cells, of the battery stack begins as a mix of all four vanadium reactants, which causes the battery to consume more energy to reach its normal charged state. Eventually a condition of 80% SOC is reached; but where the residue consists of a mix of the remaining three vanadium reactant ions. The residue ions will work out to a near normal mix of depleted ions after a few cycles of the flow battery operation. As mentioned, this conventional method requires a long down-time for the flow battery system 250, when no charging is being perfomed, as the electrolytes are mixed together. This conventional method also requires considerable pumping power to completely transfer the contents of the storage tanks 201L and 201R into one another several times until uniformity is reached. Still further, with this conventional method, considerable energy storage is lost as some of the electrolyte has to be converted by as much as three valence states to reach a normal charged state.

### SUMMARY

One or more embodiments include a flow battery system, including a feed system configured to at least feed positive electrolyte transported from a first storage tank, storing the positive electrolyte, to a positive inlet of a battery stack configured for transport to a first half cell of a battery cell of the battery stack, and configured to feed negative electrolyte transported from a second storage tank, storing the negative electrolyte, to a negative inlet of the battery stack configured for transport to a second half cell of the battery cell, a return system configured to at least return charged electrolyte transported from the first half cell to the first storage tank and to return charged electrolyte transported from the second half cell to the second storage tank, and a controller to control a polarity switching of the flow battery system to selectively control at least one of the feed system and the return system, so positive electrolyte, from the first storage tank, transported in the feed system to the battery stack is applied a negative charge by the battery stack and then returned by the return system to the second storage tank, and so negative electrolyte, from the second storage tank, transported in the feed system to the battery stack is applied a positive charge by the battery stack and then returned by the return system to the first storage tank.

The controller may be at least one of a valve controller in feed system and a valve controller in the return system, and the selective control to perform the polarity switching may be performed based on a determined ion reactant imbalance between electrolytes stored in the first storage tank and the second storage tank.

The controller may further include a controller unit, including one or more processing devices, in communication with one or more of the valve controller in feed system, the valve controller in the return system, wherein the controller unit determines when to perform the polarity switching of the flow battery system based upon the determined ion reactant imbalance.

The flow battery system may include one or more state of charge (SOC) sensors configured to determine an SOC of the positive and/or negative electrolytes in the flow battery system, and wherein the controller uses the determined SOC to determine when to reverse the controlled polarity switching of the flow battery system. The flow battery system may include one or more flow sensors configured to determine an amount of flow of electrolytes in the flow battery system after the polarity switching occurs to determine when to reverse the controlled polarity switching of the flow battery system.

The controller may determine when to perform the polarity switching of the flow battery system based upon a determination of a sufficiently discharged state of an electrolyte in the flow battery system. The sufficiently discharged state of electrolyte may be a 20/80 state of charge (SOC) of the positive or negative electrolyte stored in the first or second storage tanks.

The controlling of the polarity switching of the flow battery system may include at least one of controlling the feed system to feed the positive electrolyte transported from the first storage tank to the negative inlet of the battery stack and to feed the negative electrolyte transported from the second storage tank to the positive inlet of the battery stack and controlling the return system to return the charged electrolyte transported from the first half cell to the second storage tank and to return the charged electrolyte from the second half cell to the first storage tank. The controlling of the return system may further include controlling a battery lead system to switch a polarity of first and second poles of the battery stack so the first half cell applies a negative charge and the second half cell applies a positive charge.

The flow battery system may include a battery lead system including a switch for switching polarities of first and second poles of the battery stack, and the battery stack may include the battery cell, having the first half cell and the second half cell, configured so electrolyte transported through the first half cell is charged by the first pole and electrolyte transported through the second half cell is charged based on the second pole, the first pole and the second pole being opposite poles. The flow battery system may further include the first storage tank storing the positive electrolyte and the second storage tank storing the negative electrolyte.

The controller may control the flow battery system to control the polarity switching of the flow battery system by controlling the polarity of first and second poles of the battery stack, to change from a first set polarity, where the first half cell applies the positive charge and the second half cell applies the negative charge, to a second set polarity, where the first half cell applies the negative charge and the second half cell applies the positive charge, upon a determined ion reactant imbalance between electrolytes stored in the first storage tank and the second storage tank. The ion reactant imbalance determination may be based upon a determined excess in volume of electrolyte in the first storage tank and/or the second storage tank.

The controlling of the polarity switching of the flow battery system may include controlling the return system, with the return system being configured so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed. The controller may control the polarity switching of the flow battery system to selectively control the return system and a battery lead system for the battery stack, wherein the controlling of the battery lead system includes controlling a polarity of first and second poles of the battery stack, to change from a first set polarity, where the first half cell applies the positive charge and the second half cell applies the negative charge, to a second set polarity, where the first half cell applies the negative charge and the second half cell applies the positive charge. The controller may perform the polarity switching of the flow battery system when an ion reactant imbalance is determined between electrolytes stored in the first storage tank and the second storage tank. Upon a determined stopping point of the polarity switching, the controller may control the flow battery system to stop the polarity switching and be set to a normal mode, which includes controlling a switching of the polarity of the first and second poles so the first half cell applies the positive charge and the second half cell applies the negative charge and controlling the return system to return the charged electrolyte transported from the first half cell to the first storage tank and to return the charged electrolyte from the second half cell to the second storage tank. The determined stopping point may be determined to be before a time when plural cycles of a volume of electrolyte of one of the first or second storage tanks has flowed through one or more battery stacks of the flow battery system. The first half cell and the second half cell may be in fluid separation in the battery cell by a neutral or reversible exchange membrane, distinct from a cation exchange membrane and an anion exchange membrane.

The controlling of the polarity switching of the flow battery system may include controlling the feed system, with the feed system being configured so as to feed the positive electrolyte transported from the first storage tank to the negative inlet of the battery stack and to feed the negative electrolyte transported from the second storage tank to the positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed. The controller may perform the polarity switching of the flow battery system when an ion reactant imbalance is determined between electrolytes stored in the first storage tank and the second storage tank. Upon a determined stopping point of the polarity switching of the flow battery system, the controller may control the flow battery system to stop the polarity switching and be set to a normal mode, which includes controlling the feed system to feed the stored positive electrolyte transported from the first storage tank to the positive inlet of the battery stack and to feed the stored negative electrolyte transported from the second storage tank to the negative inlet of the battery stack. The determined stopping point may be determined to occur after at time when at least plural cycles of a volume of electrolyte of one of the first or second storage tanks has flowed through battery stacks of the flow battery system. The first half cell and the second half cell may be in fluid separation by a cation exchange membrane or an anion exchange membrane.

The electrolytes may include positive and negative electrolytes that respectively are single elemental reactants. The positive electrolyte may be a VO₂⁺/VO²⁺ couple and the negative electrolyte is a V³⁺/V²⁺ couple.

One or more embodiments include a flow battery system, including a battery stack including a battery cell, including a first half cell and a second half cell, configured so electrolyte transported through the first half cell is charged based on a first pole of the battery stack and electrolyte transported through the second half cell is charged based on a second pole of the battery stack, the first pole and the second pole being opposite poles, a first storage tank storing positive electrolyte, a second storage tank storing negative electrolyte, a feed system configured to at least feed the positive electrolyte transported from the first storage tank to the battery stack and to feed the negative electrolyte transported from the second storage tank to the battery stack, a return system configured to at least return charged electrolyte transported from the first half cell to the first storage tank and to return charged electrolyte transported from the second half cell to the second storage tank, and a controller to control a polarity switching of the flow battery system to rebalance electrolyte ion reactant concentrations of the positive electrolyte stored in the first storage tank and/or negative electrolyte stored in the second storage tank, by positive electrolyte, from the first storage tank, transported in the feed system to the battery stack being applied a negative charge by the battery stack and then being returned by the return system to the second storage tank, and by negative electrolyte, from the second storage tank, transported in the feed system to the battery stack being applied a positive charge by the battery stack and then being returned by the return system to the first storage tank.

The electrolytes may include positive and negative electrolytes that respectively are single elemental reactants. The positive electrolyte may be a VO₂⁺/VO²⁺ couple and the negative electrolyte is a V³⁺/V²⁺ couple.

In the controlling of the polarity switching of the flow battery system, the controller may further control a setting of a polarity of the battery stack, between a first set polarity where the first pole is controlled to be a positive pole and the second pole is controlled to be a negative pole and a second set polarity where the first pole is controlled to be the negative pole and the second pole is controlled to be the positive pole, such that the polarity switching of the flow battery system is performed by changing the polarity of the battery stack from the first set polarity to the second set polarity, so that the positive electrolyte fed by the feed system from the first storage tank to the first half cell is negatively charged and the negative electrolyte fed by the feed system from the second storage tank to the second half cell is positively charged.

In the controlling of the polarity switching of the flow battery system, the return system may be configured so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed.

In the controlling of the polarity switching of the flow battery system, the feed system may be configured so as to feed the positive electrolyte transported from the first storage tank to a negative inlet of the battery stack and to feed the negative electrolyte transported from the second storage tank to a positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed.

One or more embodiments include a flow battery system, including a controller to control a polarity switching of the flow battery system to selectively control at least one of a feed system and a return system for a battery stack of the flow battery system, to rebalance electrolyte ion reactant concentrations of positive electrolyte stored in a first storage tank and/or negative electrolyte stored in a second storage tank, so the positive electrolyte, from the first storage tank, transported in the feed system to the battery stack is applied a negative charge by the battery stack and then returned by the return system to the second storage tank, and so the negative electrolyte, from the second storage tank, transported in the feed system to the battery stack is applied a positive charge by the battery stack and then returned by the return system to the first storage tank, to rebalance the electrolyte ion reactant concentrations, such that the feed system is configured to at least feed the positive electrolyte transported from the first storage tank to a positive inlet of the battery stack configured for transport to a first half cell of a battery cell of the battery stack, and configured to feed the negative electrolyte transported from the second storage tank to a negative inlet of the battery stack configured for transport to a second half cell of the battery cell, and such that the return system is configured to at least return charged electrolyte transported from the first half cell to the first storage tank and to return charged electrolyte transported from the second half cell to the second storage tank.

One or more embodiments include a method for controlling a flow battery system, the method including feeding positive electrolyte transported from a first storage tank, storing the positive electrolyte, to a positive inlet of a battery stack configured for transport to a first half cell of a battery cell of the battery stack, and feeding negative electrolyte transported from a second storage tank, storing the negative electrolyte, to a negative inlet of the battery stack configured for transport to a second half cell of the battery cell, returning charged electrolyte transported from the first half cell to the first storage tank and returning charged electrolyte transported from the second half cell to the second storage tank, and selectively controlling a polarity switching of the flow battery system by controlling at least one of a changing of the feeding of electrolyte to the battery stack and changing of the returning of charged electrolyte from the battery stack to the first and second storage tanks, so positive electrolyte, from the first storage tank, transported in the feed system to the battery stack is applied a negative charge by the battery stack and then returned by the return system to the second storage tank, and so negative electrolyte, from the second storage tank, transported in the feed system to the battery stack is applied a positive charge by the battery stack and then returned by the return system to the first storage tank.

The polarity switching of the flow battery system may be performed based on a determined ion reactant imbalance between electrolytes stored in the first storage tank and the second storage tank.

The selective controlling of the polarity switching may include selectively controlling one of a valve controller in a feed system of the flow battery system to perform the changing of the feeding of electrolyte to the battery stack and a valve controller in a return system of the flow battery system to perform the changing of the returning of charged electrolyte from the battery stack to the first and second storage tanks, based on a determined ion reactant imbalance between electrolytes stored in the first storage tank and the second storage tank. The method may further include determining when to perform the polarity switching of the flow battery system based upon the determined ion reactant imbalance between electrolytes in the first storage tank and second storage tank.

The method may further include monitoring a state of charge (SOC) of the positive and/or negative electrolytes in the flow battery system, and determining when to reverse the controlled polarity switching of the flow battery system based on the monitored SOC. The method may further include monitoring an amount of flow of electrolytes in the flow battery system after the polarity switching to determine when to reverse the controlled polarity switching of the flow battery system. The method may further include determining when to perform the polarity switching of the flow battery system based upon a determination of a sufficiently discharged state of an electrolyte in the flow battery system. The sufficiently discharged state of electrolyte may be a 20/80 state of charge (SOC) of the positive or negative electrolyte stored in the first or second storage tanks.

The battery stack may include the battery cell, having the first half cell and the second half cell, configured so electrolyte transported through the first half cell is charged by a first pole of the battery stack and electrolyte transported through the second half cell is charged based on a second pole of the battery stack, the first pole and the second pole being opposite poles.

The controlling of the polarity switching may include controlling a changing of the polarity of the battery stack, by controlling a polarity of the first and second poles of the battery stack, to change from a first set polarity, where the first half cell applies the positive charge and the second half cell applies the negative charge, to a second set polarity, where the first half cell applies the negative charge and the second half cell applies the positive charge, upon a determined ion reactant imbalance between electrolytes stored in the first storage tank and the second storage tank. The method may further include monitoring volumes of electrolyte stored in the first and/or second storage tanks and determining the ion reactant imbalance based upon a determined excess in the monitored volume of electrolyte in the first or second storage tanks.

The controlling of the polarity switching may include controlling the changing of the returning of charged electrolyte from the battery stack to the first and second storage tanks, so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed. The controlling of the polarity switching may further include a changing of a polarity of the battery stack, including controlling a polarity of first and second poles of the battery stack to change from a first set polarity, where the first half cell applies the positive charge and the second half cell applies the negative charge, to a second set polarity, where the first half cell applies the negative charge and the second half cell applies the positive charge, when the polarity switch of the flow battery system is performed and to subsequently switch back to the first set polarity when the polarity switching is stopped. The method may further include determining to stop the polarity switching before a time when plural cycles of a volume of electrolyte of one of the first or second storage tanks has flowed through one or more battery stacks of the flow battery system. The first half cell and the second half cell may be in fluid separation in the battery cell by a neutral or reversible exchange membrane, distinct from a cation exchange membrane and an anion exchange membrane.

The controlling of the polarity switching may include controlling the changing of the feeding of electrolyte to the battery stack, so as to feed the positive electrolyte transported from the first storage tank to the negative inlet of the battery stack and to feed the negative electrolyte transported from the second storage tank to the positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed. Upon a determined stopping point of the polarity switching of the flow battery system, the controlling of the polarity switching may control the flow battery system to stop the polarity switching and the flow battery system to be set to a normal mode, which includes controlling the feed system to feed the stored positive electrolyte transported from the first storage tank to the positive inlet of the battery stack and to feed the stored negative electrolyte transported from the second storage tank to the negative inlet of the battery stack. The method may further include determining the stopping point to occur after a time when at least plural cycles of a volume of electrolyte of one of the first or second storage tanks has flowed through battery stacks of the flow battery system. The first half cell and the second half cell may be in fluid separation by a cation exchange membrane or an anion exchange membrane.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates conventional flow battery system during a normal battery charging operation;

FIG. 2 illustrates a conventional flow battery electrolyte mixing system;

FIG. 3 illustrates a flow battery being charged after electric poles have been reversed, according to one or more embodiments;

FIG. 4 illustrates a flow battery being charged after electric poles have been switched and output lines have been reversed, according to one or more embodiments;

FIG. 5 illustrates a flow battery being charged after input lines have been reversed, according to one or more embodiments;

FIG. 6 illustrates plots of example energy requirements of various example rebalancing methods against the ratio of accidental mixing, according to one or more embodiments; and

FIG. 7 illustrates plots of a number of passes implemented to charge a flow battery as a function of the number of passes to normally charge a flow battery depending on a state of charge, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

One or more embodiments relate to a redox flow battery system that may correct for determined ion reactant imbalance(s) that may occur between positive and negative electrolytes after prolonged periods of use. Depending on electrolyte solution, ions cross the battery membrane in both directions due to leakage through the membrane and due to corrections made for osmotic water transfer. These processes are asymmetric and generally result in a net excess of ions on the negative side of the flow battery when cation exchange membranes are used, with net excess of water on the positive side of the flow battery. In one or more embodiments, such ion reactant imbalances can be corrected by causing the electrolyte flows to be juxtaposed causing a polarity switching of the flow battery. One or more embodiments affect a polarity switch of the flow battery. In one or more embodiment, such polarity switching methods described herein can shorten the time required to rebalance a redox flow battery. In one or more embodiments, using an example where the redox flow battery is a Vanadium Redox Flow Batteries (VRFB), the energy requirements may be reduced by 23 to 28% and the time between rebalancing procedures may be extended. One or more embodiments may determine to rebalance a flow battery based upon a predetermined expiration of time, volume of electrolyte transport, and/or other factors, such as determined imbalances in concentrations of the positive and/or negative electrolyte, including the above example concentrations discussed with regard to U.S. Pat. No. 6,764,789, noting that alternative concentrations and/or concentration ranges are also available as thresholds for when rebalancing discussed herein should or may desirably be performed. As described herein, such rebalancing may be automatically performed, e.g., based upon such determining factors, by a controller of a flow battery system of one or more embodiments.

As discussed above, according to one or more embodiments, redox flow batteries have two liquid electrolytes; a positive electrolyte or catholyte, and a negative electrolyte or anolyte. The two electrolytes are separated from one another by an ion exchange membrane. Here, the two electrodes may be inert and only, or primarily, serve to collect or distribute the electric charge to or from one or more battery cells of one or more respective battery stacks. The membrane divides the battery cell into two half-cells. Depending on embodiment, each half-cell may generally include a rectangular frame, having some thickness, around a central rectangular cavity with the membrane stretched across one side of the frame and a conductive graphite plate serving as the electrode and extending across the other side of the frame, noting that embodiments are not limited to the same. A rectangle of electrically conductive carbon felt may be cut to fit inside and fill the entire cavity, for example, of the half-cell to assist in collecting or distributing of electric charge to or from the electrolyte. Positive electrolyte fills the positive half-cell and negative electrolyte fills the negative half-cell and flows within the carbon felt that occupies each half-cell. In the case of a vanadium redox flow battery (VRFB) embodiment, the positive electrolyte contains V(5)N(4) vanadium ions and the negative electrolyte contains V(2)N(3) vanadium ions, and both electrolytes consist of a mixture of sulfuric acid and water. In a flow battery system the positive and negative electrolyte solutions are stored in storage tanks external to the battery stack and pumps may be used to feed the electrolytes through their respective half-cells during the charging and discharging periods of operation, noting that embodiments are not limited to the same.

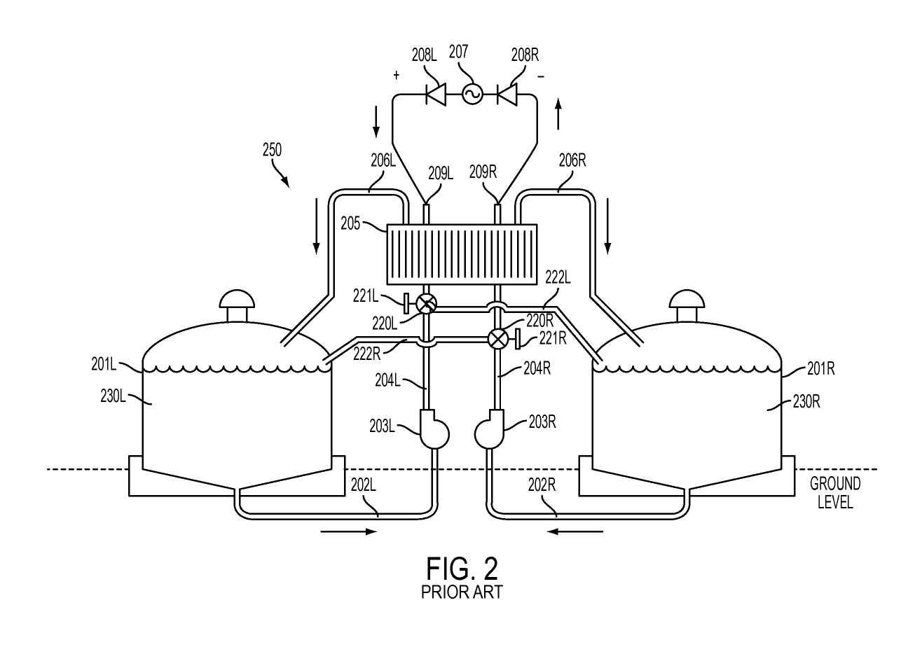

In addition, one or more embodiments relate to a systemic problem encountered in some redox flow batteries, such as VRFBs, referred to as “water transfer”, where water transfer takes place across the half-cell membrane because of osmosis and leakage. Accordingly, one or more embodiments include a flow battery system and method that rebalances the flow battery, collectively referred to herein as “polarity switching”, whereby the flow battery's electrodes and/or the flow battery's electrolytes are reversed in polarity, thus eliminating or minimizing the need to rebalance the flow battery by the conventional stopping of the flow battery charging/discharging operations and subsequent mixing of the electrolytes before flow battery operations are restarted. One or more embodiments provide a more energy efficient method of rebalancing a VRFB, for example, compared to the conventional approach discussed above with regard to FIG. 2. One or more embodiments reduce the time required to rebalance such a VRFB. Still further, one or more embodiments include a flow battery system and method of polarity switching that may be fully automated, and thus contribute to the operational efficiency of such a VRFB.

Herein, again, one or more embodiments involve the use of “polarity switching” to correct unbalanced ion reactants in the electrolyte tanks of redox flow battery, such as vanadium ion reactants. Rather than mixing, or only mixing, the positive and negative electrolytes together to correct unbalanced reactants, one or more embodiments include changing the polarity of the entire flow battery. According to one or more embodiments, in such a polarity switching approach, in the operation of the flow battery system, the positive electrolyte is considered to be the negative electrolyte and the negative electrolyte is considered to be the positive electrolyte, and the flow battery system operates under these new considerations. Depending on embodiment, once the polarity is reversed, where formally the negative tanks contained an excess concentration of vanadium reactants, now the positive tanks have an excess of reactants, so the entire flow battery may be in a reverse state of unbalance.

Here, after such an example polarity switching is performed, the flow battery may be recharged back to its fully charged condition. This may require more energy then would be required by the conventional method of FIG. 2, where the electrolytes are merely mixed together, however, the polarity switching according to one or more embodiments may only be needed or desired half as often as the conventional mixing method. For example, if it requires thirty days for the reactants in a VRFB to become unbalanced; then using the conventional method of FIG. 2, the electrolyte mixing would have to be performed every thirty days. Rather, as only an example, using a polarity switching approach according to one or more embodiments, after the polarity switch the flow battery may be put into a reverse unbalance state, which in this example, may then require 30 days of operation to work its way to a balance electrolyte state, and another 30 days to work its way to the usual unbalanced state with an excess concentration of reactants in the negative tanks. So, in an embodiment, although more energy may be needed to fully charge a polarity switched flow battery back to its charged state, this rebalancing only has to be performed half as often, which yields about a 21 to 28 percent gross energy savings compared to the conventional approach of FIG. 2. This will be discussed in more detail below with regard to Table 1. Added to the energy savings, there is the advantage in one or more embodiments of not having to turn the flow battery off while performing a mixing of the electrolytes.

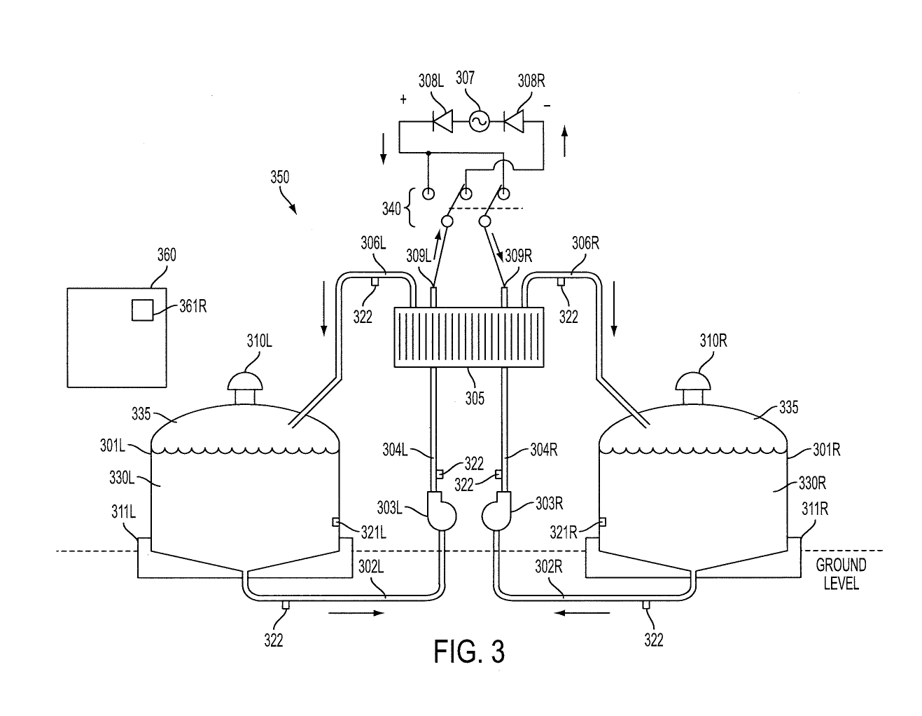

Herein, using a charging phase as an example, in one or more embodiments the flow battery remaining on means that electrolytes are still being transported through the battery stack(s) and respective electrolytes are being charged. Using the below FIGS. 3-5 as only examples: when the flow battery system 350 is on and the ‘polarity’ of the flow battery system 350 is switched, the previously positive electrolyte from storage tank 301L is now charged as a negative electrolyte and returned to storage tank 301L, and the previously negative electrolyte from storage tank 301R is now charged as a positive electrolyte and returned to storage tank 301R; when the flow battery system 450 is on and the ‘polarity’ of the flow battery system 450 is switched, the previously positive electrolyte from storage tank 401L is now charged as a negative electrolyte and returned to storage tank 401R, and the previously negative electrolyte from storage tank 401R is now charged as a positive electrolyte and returned to storage tank 401L; and when the flow battery system 550 is on and the ‘polarity’ of the flow battery system 550 is switched, the previously positive electrolyte from storage tank 501L is now charged as a negative electrolyte and returned to storage tank 501R, and the previously negative electrolyte from storage tank 501R is now charged as a positive electrolyte and returned to storage tank 501L.

Accordingly, FIG. 3 illustrates a flow battery being charged after electric poles have been reversed, according to one or more embodiments. In the flow battery system 350 of FIG. 3, storage tanks 301L and 301R store respective electrolytes, so that electrolyte is transported through lines 302L and 302R by pumps 303L and 303R toward battery stack 305 using lines 304L and 304R. After transporting through battery stack 305, electrolyte is respectively returned to storage tanks 301L and 301R through lines 306L and 306R. Each of the storage tanks 301L and 301R may include snorkels 310L and 310R. As illustrated, battery stack 305 may have at least two terminals, e.g., an initially designated positive terminal 309L and initially designated negative terminal 309R. Each storage tank may include a drip or spray mechanism to drip or spray returning electrolyte onto the top of the old or existing electrolyte already contained in the storage tank. Thus, in this ‘initial’ example, using the initially designated negative battery terminal 309R, the power source 307 and the diode inverters 308L and 308R may operate in a charging mode to supply current to the initially designated positive battery terminal 309L.

In this method, the direction of the charging current entering the battery stack 305 can be reversed just prior to re-charging the flow battery. Thus, battery terminal 309L, which had been operating as the positive battery terminal, may now be connected to the negative pole of the inverter using DPDT switch 340. Likewise, the DPDT switch 340 may connect the initially (or formerly) designated negative battery terminal 309R to the positive output of the inverter. The DPDT switch 340 connected to the battery terminals 309L and 309R may be referred to as a battery lead system, for example. For only explanatory purposes, assuming that the battery stack and membrane have no preference as to which side is positive or negative, the flow battery may then begin operating in reverse, i.e., using battery terminal 309L, the power source 207 and the diode inverters 308L and 308R may operate a charging mode to supply current to battery terminal 309R. The 20/80 mix of V(5)/V(4) discharged positive reactants passes through the polarity reversed battery stack 305 and emerges as a 80/20 mix of V(2)/V(3) charged negative reactants after a number of passes through the battery stack 305. Likewise, the 20/80 mix of V(2)N(3) discharged negative reactants on the left side of the example VRFB passes through the polarity switched battery stack 305 and is converted to a 80/20 mix of V(5)/V(4) charged positive reactants after a number of passes through the battery stack 305. The left tank 301L becomes the new negative electrolyte storage tank and likewise the right tank 301R becomes the new positive electrolyte storage tank. Once switch 340 is flipped to its new position to cause this rebalancing of the electrolyte, switch 340 may be controlled to remain in its new position during all subsequent flow battery operations until the next rebalancing of electrolyte, when the switch 340 may be flipped again to reverse the polarity of the battery stack, e.g., in this example to reverse the polarity back to the example initial designations. Also, in this example when the switch 340 has been flipped, and newly charged electrolyte is returned to storage tanks 301L and 301R, the respective electrolytes 330L may be considered a mixture of newly charged negative electrolyte added to old positive electrolyte and electrolyte 330R may be considered a mixture of newly charged positive electrolyte added to old negative electrolyte.

It is important to note that this method of changing the polarity of the input inverter may not affect the composition of the electrolytes in the two tanks. The tank on the right still has an excess of reactive ions; but after the polarity switch is performed, and after the ions in the right tank are converted from negative to positive ions, it will now become the positive electrolyte tank that has excess reactant ions. After the flow battery resumes normal operation the reactant ions will continue to migrate across the membrane substantially from positive to negative side until the negative side again has an excess of reactant ions. Once the flow battery again becomes inefficient from an excess of reactants on the negative side, the rebalancing of electrolytes will have to be performed again. But the time interval between necessary rebalancing of the electrolytes is approximately twice that required using the conventional mixing procedure of FIG. 2. For example, as demonstrated in the below example Table 1, the net effect is that averaged over time, the electrical polarity switching of the inverter (Method 1) yields approximately a 28.3% advantage over the conventional mixing of the electrolytes, and the savings of the time and cost of pumping the electrolyte between the tanks.

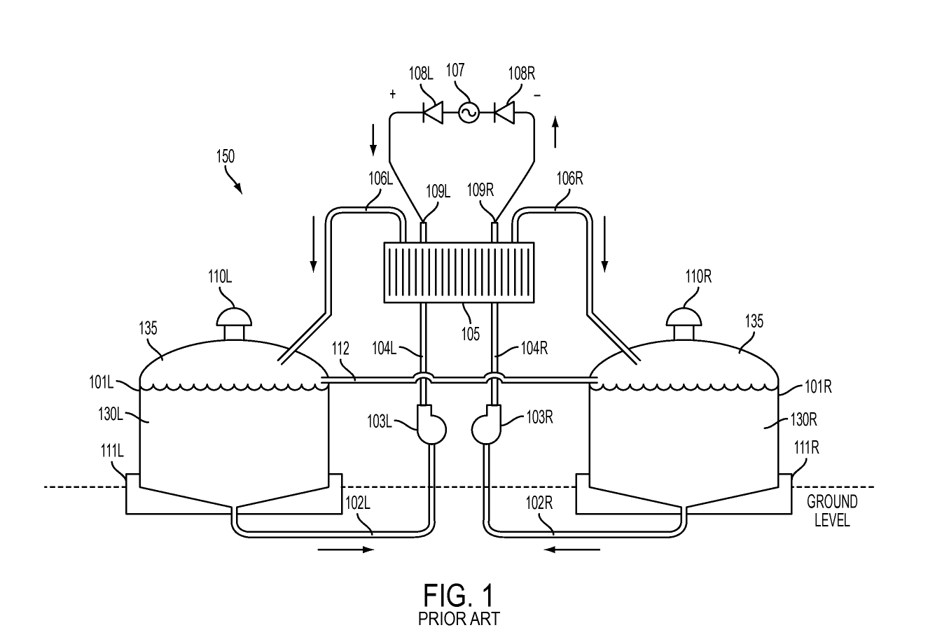

Accordingly, in implementing the method described with regard to FIG. 3, the rectifier/inverter electronics may be equipped with a double-pole double-throw (DPDT) switch wired for pole reversal, as only an example. In addition, with this approach, arrangement of valves, pumps, and piping of the flow battery system demonstrated in FIG. 1 may again be implemented, as long as there is an approach for reversing the poles of the flow battery. Further, one or more embodiments may include just a controller and/or switching mechanism, that could be selectively added to or incorporated into a conventional flow battery system, such as that demonstrated in FIG. 1. In one or more embodiment, re-balancing of the flow battery usually begins with the flow battery in the discharged state. Then, the example DPDT switch may be set to reverse the direction of current flow into the battery stack as the flow battery is being re-charged. This causes the positive electrolyte to be charged up and converted to a negative electrolyte condition while the negative electrolyte is converted to a charged positive electrolyte. This may only be possible in a redox flow battery where both the positive and negative reactants are made up of ions that can be converted to any of four, for example, valence states within their electrolyte solutions. For example, the flow battery may be a VRFB, and the positive and negative reactants may be made up of vanadium ions. After the electrical poles have been reversed the flow battery may thereafter be maintained and operated in the polarity reversed condition. Accordingly, in the polarity reversed condition, what was formally the positive electrolyte storage tank now becomes the negative electrolyte storage tank, and vice versa. In one or more embodiments, to implement this polarity reversal, neutral or reversible ion exchange membranes that are neither cationic nor anionic, and which can be operated in the reversed condition, may be used. This reversed polarity may be maintained until the electrolytes of the flow battery again become unbalanced and another polarity switch operation is desired.

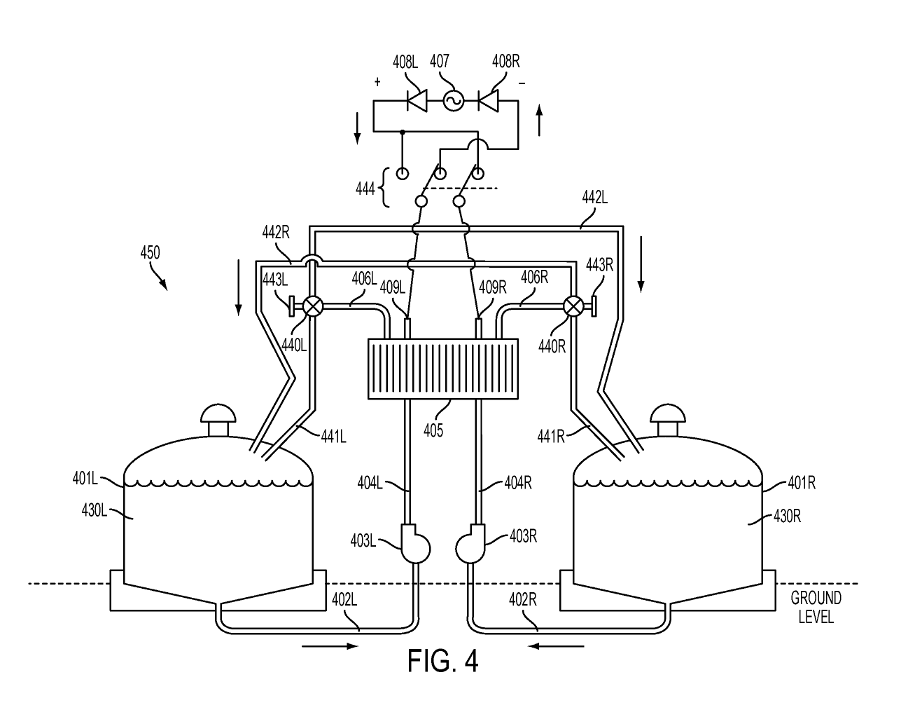

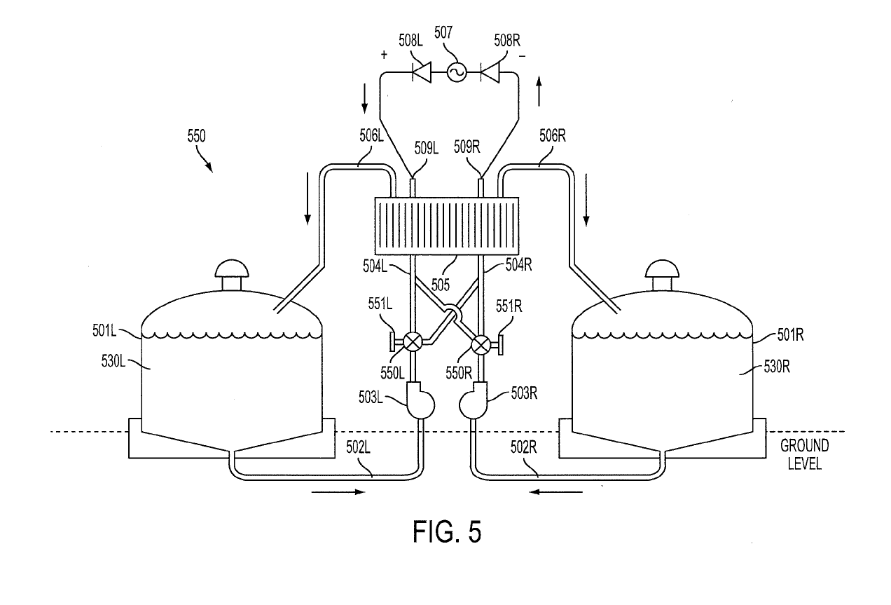

In addition, FIG. 3 further illustrates a controller 360 that is connected, or at least in communication with one or more of the pumps 303L and 303R, and valves, including any variable opening valves that may be arranged just prior to the battery stack 305 in lines 304L and 304R, for example, or any other electrolyte transportation elements in the flow battery system 350. The controller 360 includes one or more processing devices or microcontroller 361, or the like hardware elements, that may implement any desired controlling of the elements of the flow battery system 350 for transportation of electrolyte through the battery stack 305, e.g., for charge or discharge through the battery cells of the battery stack 305, and control of any polarity switching of the battery terminals 309L and 309R, such as through control of the example DPDT switch 340. In one or more embodiments, depending on configuration, the controller 360 may control a variance in such a variable opening of the example variable opening valves, operation of any return pumps for returning electrolyte through lines 306L and 306R, control of any feed pumps 303L and 303R, control a ceasing of such positive and negative electrolyte transportation for maintenance of stored charge in the storage tanks 301L and 301R, charging or discharging of the respective electrolytes, and reversal of such polarities, as only examples. As another example, such a controller 360 may further be in communication with one or more valve controllers, with such configurations as demonstrated in FIGS. 4 and 5, for such respective polarity switching operations using such valve controllers. Similarly, depending on embodiment and respective elements and configurations, each of the flow battery embodiments described herein include such a controller configured to control elements of the respective flow battery systems charge, discharge, maintenance of charge, reversal of polarity, and/or selective reversal inlet or outlet of electrolyte lines to/from the battery stack Accordingly, depending on desired implementation, aspects of different embodiments described herein may be selectively combined and respectively controlled by such a controller.

FIG. 4 illustrates a flow battery being charged after electric poles have been switched and output lines have been reversed, according to one or more embodiments. In the flow battery system 450 of FIG. 4, storage tanks 401L and 401R store respective electrolytes, so that electrolyte is transported through lines 402L and 402R by pumps 403L and 403R toward battery stack 405 using lines 404L and 404R. After transporting through battery stack 405, electrolyte is respectively returned to storage tanks 401L and 401R through any of lines 441L, 441R, 442L, and 442R, as explained below. As illustrated, battery stack 405 may have at least two terminals, e.g., an initially designated positive terminal 409L and initially designated negative terminal 409R. Thus, in this ‘initial’ example, using the initially designated negative battery terminal 409R, the power source 407 and the diode inverters 408L and 408R may operate in a charging mode to supply current to the initially designated positive battery terminal 409L.

Similar to the approach of FIG. 3, the flow battery system 450 of FIG. 4 includes a DPDT switch 444 installed between the inverter/rectifier 408L, 407, and 408R and the battery stack 405 to allow for the electrical pole reversal of the battery stack 405. The DPDT switch 444 connected to the battery terminals 409L and 409R may be referred to as a battery lead system, for example. In addition, the flow battery system 450 also includes three-port fluid control valves 440L and 440R on the positive and negative electrolyte exit lines 409L and 409R, illustrated at the top of battery stack 405. In this approach, at an initiation of flow battery re-balancing, valves 440L and 440R may be re-set by controllers 443L and 443R to divert electrolyte into their opposite storage tanks 401R and 401L. Thus, positively charged electrolyte emerging from the left side of the battery stack 405 may be diverted by valve 440L into the top of the formally designated negative storage tank 401R. Likewise, negatively charged electrolyte emerging from the right side of the battery stack 405 may be diverted by valve 440R to the formally designated positive storage tank 401L. Simultaneously, DPDT switch 444 may also be switched to reverse the polarity of the battery stack 405 so that the positive side of the battery stack 405 begins to deliver a negative charge to passing through electrolyte and the negative side of the battery stack 405 delivers a positive charge to passing through the electrolyte. As a result of the setting of switch 444 and valve controller 443L setting, at the initiation of this rebalancing method, old electrolyte from the outlet or bottom of the positive storage tank 401L is still sent through the left side of the battery stack 405, but it is now given a negative charge. The negatively charged electrolyte emerges from the left side of the battery stack 405, travels through pipe 406L to valve 440L where it is now directed into negative storage tank 401R. Similarly, as a result of the setting of switch 444 and valve controller 443R setting, at the initiation of this rebalancing method, old electrolyte from the outlet or bottom of the negative storage tank 401R is still sent through the right side of the battery stack 405, but it is now given a positive charge. The positively charged electrolyte emerges from the right side of the battery stack 405, travels through pipe 406R to valve 440R where it is now directed into positive storage tank 401L. Thus, in this example when the switch 444 has been flipped and controllers 443L and 443R are set, where newly charged electrolyte is returned to storage tanks 401L and 401R, the respective electrolytes 430L may be considered a mixture of newly charged positive electrolyte added to old positive electrolyte and electrolyte 430R may be considered a mixture of newly charged negative electrolyte added to old negative electrolyte.

In one or more embodiments, after approximately one tank volume of electrolyte has been transferred from storage tanks 401L and 401R, through battery stack 405, and into the opposite storage tanks 401R and 401L, the valves 440L and 440R may be re-set by controllers 443L and 443R to their initial settings. Simultaneously, the DPDT switch 444 may also be returned to its initial setting. The flow battery may now begin to operate in its normal mode with electrolyte exiting the positive storage tank 401L and flowing through the battery stack 405 being given a positive charge, and then returned to positive storage tank 401L, and electrolyte existing the negative storage tank 401R and flowing through the battery stack 405 being given a negative charge, and then return to the negative storage tank 401R. The flow battery is then operated for a few cycles to complete the charging process, thus completing rebalancing of the flow battery. As in one or more previous discussed embodiments, such rebalancing may be implemented by the controller of the flow battery system 450, such as illustrated in FIG. 3.

Briefly, there may be an assumption that newly charged electrolyte returns to the top of its respective storage tank, and that old electrolyte is withdrawn from the bottom of the tank with very little mixing of the two electrolyte species within each storage tank. However, in one or more embodiments, even though addition and removal of electrolyte to/from each storage tank is done carefully to cause little mixing of electrolyte within the storage tanks, none-the-less some mixing may take place. In an embodiment, as a reasonable estimate, it may be assumed that after one storage tank volume of electrolyte has been exchanged between storage tanks, about 10 to 20% of the electrolyte will be in the wrong storage tank, i.e., not in the intended storage tank. This “accidental” mixing of electrolyte may occur in both of the methods described with regard to FIGS. 4 and 5, and has been taken into account in computations of efficiency described herein, such as in the below discussed Table 1. Depending on embodiment, accidental mixing may actually serve as a useful or intended long term purpose of correcting some of the other electrolyte ingredients that may also slowly become unbalanced during the flow battery's operation.

Note that during the example brief one-cycle period when the flow battery is being operated with its polarity reversed, the membranes within the battery stack 405 are also operating in reverse. If neutral or reversible membranes are being used, that may not be a concern. However, if cation or anion membranes are being used, the flow battery will be very inefficient during this reversed period, and some harm may occur to the membranes, depending on their composition. As a potential benefit, in one or more embodiments, this brief period of pole reversal may serve to unclog the membranes of residues that may have built up over time. Such a consideration may also be made with the flow battery system 350 of FIG. 3, since the polarity may be reversed for at least a cycle, if not many cycles.

As demonstrated above, the flow battery systems and methods of FIGS. 3 and 4 use an example double pole double throw (DPDT) switch between the inverter/rectifier circuitry and the battery stack. In addition, as discussed with regard to the flow battery system and method of FIG. 4, and with regard to the below flow battery system and method of FIG. 5, example three-port valves to redirect the flow of electrolyte into or out of the battery stack are used. Though embodiments have been described above with regard to FIGS. 3 and 4, and with regard to the below discussed FIG. 5, it is respectfully submitted that these descriptions are only for explanatory purposes, and embodiments of the invention are not limited to strict implementations of the same.

Accordingly, FIG. 5 illustrates a flow battery being charged after input lines have been reversed, according to one or more embodiments. In the flow battery system 550 of FIG. 5, storage tanks 501L and 501R store respective electrolytes, so that electrolyte is transported through lines 502L and 502R by pumps 503L and 503R toward battery stack 505 using lines 504L and 504R, as explained below. After transporting through battery stack 505, electrolyte is respectively returned to storage tanks 501L and 501R through respective lines 506L and 506R. As illustrated, battery stack 505 may have at least two battery terminals 509L and 509R. The two battery terminals 509L and 509R may be considered a battery lead system. Using battery terminal 509R, the power source 507 and the diode inverters 508L and 508R may operate in a charging mode to supply current to battery terminal 509L.

In this method three-port fluid flow valves 550L and 550R are included in the two electrolyte lines 504L and 504R feeding the battery stack 505. The valves 550L and 550R can be set to allow either normal flow of electrolyte into the battery stack 505, or they can be set to divert the electrolyte into opposite inlet or sides of the battery stack 505. During normal operation the valve 550L is set to circulate electrolyte from the positive electrolyte storage tank 501L, to the positive side of the battery stack 505 (illustrated on the left side of the battery stack 505), and back into the positive storage tank 501L. Likewise, during normal operation, valve 550R circulates negative electrolyte on the right side of the flow battery. Rebalancing begins by controllers 551L and 551R switching valves 550L and 550R to a rebalancing mode, to redirect the respective electrolytes into the opposite storage tanks 501R and 501L. During this rebalancing process electrolyte from the positive tank 501L is passed along line 502L through pump 503L to valve 550L, which is now set to send electrolyte to the negative side of the battery stack 505 through line 504R. Similarly, during this rebalancing process electrolyte from the negative tank 501R is passed along line 502R through pump 503R to valve 550R, which is now set to send electrolyte to the positive side of the battery stack 505 through line 504L. During rebalancing, the negative and positive sides of the battery stack 505 remain unchanged in polarity except that positive electrolyte is now entering the negative side of the battery stack 505 and negative electrolyte is now entering the positive side of the battery stack 505. Depleted positive electrolyte passes through the negative side of the battery stack 505 and is converted to negative electrolyte, which then passes through line 506R to the negative storage tank 501R. Likewise, and simultaneously, negative electrolyte from storage tank 501R passes through line 502R, by the action of pump 503R, and is diverted by valve 550R to the positive side of the battery stack 505. Depleted negative electrolyte is then converted by the flow battery to positive electrolyte in the battery stack 505, which then emerges from the battery stack 505 in line 506L and then passes into the positive electrolyte storage tank 501L. Thus, in this example when the controllers 551L and 551R are set, where newly charged electrolyte is returned to storage tanks 501L and 501R, the respective electrolytes 530L may be considered a mixture of newly charged positive electrolyte added to old positive electrolyte and electrolyte 530R may be considered a mixture of newly charged negative electrolyte added to old negative electrolyte.

In an embodiment, after the entire volume of the two storage tanks 501L and 501R have been partially charged and sent to their opposite storage tanks 501R and 501L, the rebalancing procedure may be stopped, with valves 550L and 550R being commanded by their controllers 551L and 551R to return to their normal position. Thereafter, in normal operation, positive electrolyte may be returned to the positive storage tank 501L after passing through the battery stack 505, and negative electrolyte is likewise sent to the negative tank 501R after passing through the battery stack 505. Briefly, since one pass through the battery stack 505 may only be sufficient to convert some of the electrolyte to its 80/20 charged state, several additional passes through the battery stack may be required to fully charge the flow battery. As in one or more previous discussed embodiments, such rebalancing may be implemented by the controller of the flow battery system 450, such as illustrated in FIG. 3.

During normal operation of a flow battery, such as a VRFB, the electrolytes must pass through the battery stack several times to reach the charged state or discharged state. During one pass through the battery stack only a portion of the vanadium ions are able to react with their counterparts through the battery membrane. During the next pass through the battery stack the reactants have been depleted from the previous pass and therefore fewer reactions take place. This behavior can be somewhat alleviated by increasing the pumping speed during each succeeding pass, for example the controller may variably control the speeds of pumps 503L and 503R. But these techniques may be limited. In an embodiment, it may only be practical to charge up the flow battery to an 80/20 SOC and likewise discharge the flow battery down to a 20/80 SOC. The number of passes required to go from a 20/80 discharge state to an 80/20 charged state varies greatly according to a number of flow battery parameters such as voltages, temperature, flow rates, etc. Generally, depending on embodiment, an average of three passes of the electrolyte through the battery stack may be sufficient to go from one charge state to the other.

In the method described with regard to FIG. 5, different from the configuration of the flow battery of FIG. 1, for example, three-port valves are included on the electrolyte input pipes entering the battery stack. Here, in this embodiment, no changes may be required to the rectifier/inverter electronics. Accordingly, in addition to the flow battery system 550 of FIG. 5, one or more embodiments may include a method of modifying an existing flow battery system, such as that of flow battery system 150 of FIG. 1, to implement the rebalancing described above with regard to FIG. 5, e.g., by adding such three-port valves to the electrolyte input pipes and adding or modifying an existing controller to implement the described rebalancing. Accordingly, with such an embodiment, when flow battery rebalancing is initiated, two example three-port valves may be set to re-direct the electrolytes into opposite flow battery sides of the battery stack, while the rectifier/inverter electronics continues to deliver charging current to the positive side of the battery stack. In this embodiment, this process causes old discharged positive electrolyte to pass through the three-port valve to the negative fluid input side of the battery stack where it is given a negative charge. The negatively charged electrolyte then flows out of the battery stack and into the negative storage tank. When approximately all of the two electrolytes have passed into their opposite storage tank the three-port valves may be set back to their normal position. The flow battery may then be controlled to operate in the charging mode until full charge is reached. In this procedure, different from the approach discussed with regard to FIGS. 3 and 4 where the battery stacks 305 and 405 switch polarities, the battery stack 505 may be operated at its normal polarity throughout the rebalancing procedure. For example, in one or more embodiments of the flow battery system 550 of FIG. 5, since the battery stack 505 may always operated at the same polarity, e.g., based upon a same current flow direction from power source 507, the half-cell membranes of the battery stack 505 may be either cationic or anionic.

In one or more embodiments, the flow battery systems and methods of FIGS. 4 and 5 may be operated so as to switch the polarity of the electrolyte storage tanks, i.e., thereby mixing electrolytes between the storage tanks. As shown above in FIG. 4, this may be achieved while the flow battery system 450 is maintained on, the controllers 443L and 443R are set to their rebalancing modes, and while the example DPDT switch remains in its normal position, thereby allowing positively charged electrolyte to flow into the negative tank because of valve 440L and negatively charged electrolyte to flow into the positive tank because of valve 450. After the transfer, the example DPDT switch may be set to an opposite polarity and the flow battery system 450 could remain in that setting thereafter. Similarly, using the flow battery system 550 of FIG. 5, an example DPDT switching mechanism may be added similar to the configuration of FIG. 4. The DPDT switching mechanism may be set to a polarity reversal mode during the transfer portion of the rebalancing process, could remain in the polarity reversed mode thereafter. Depending on embodiment, since the polarity of the battery stacks 405 or 505 are being switched, either of these alternatives of FIGS. 4 and 5 may require that neutral membranes be used that are neither cationic nor anionic, as noted above. In an embodiment, if the flow battery, e.g., a VRFB, is equipped with both a DPDT switch on the rectifier/inverter and plural sets of three-port valves as shown in FIGS. 4 and 5, then any of the methods described with regard to FIGS. 3-5 could be used to selectively rebalance the flow battery at different times during the life of the flow battery when rebalancing is desired.

Briefly, in one or more embodiments, flow battery systems 450 and 550 may be operated in an ‘off’ mode, i.e., when current is not applied to the respective poles of the battery stacks 405 or 505, to merely perform a mixing of electrolytes between the respective storage tanks. In one or more embodiments there may also be numerous battery stacks, with independent plumbing from the respective storage tanks, so that the ‘polarity switching’ may be performed with every battery stack, or less than all battery stacks. In such a case, as only an example, in one or more embodiments, flow battery system 450 may perform ‘polarity switching’ with some battery stacks while performing only mixing with remaining battery stacks, e.g., depending on the amount desired rebalancing of the flow battery system.

In addition to the above, in one or more embodiments, one or more State Of Charge (SOC) sensors may be placed at appropriate positions in the flow battery system, such as the example SOC sensors 321L and 321R of FIG. 3, noting that alternate sensor locations and SOC measurements are also available, depending on embodiment. Signals from the SOC sensors are then used by the system controller, such as the controller 360 of FIG. 3, to determine when to initiate rebalancing of the flow battery. In one or more embodiments, the flow battery system also includes one or more flow meters at appropriate locations in the flow battery system, such as the example flow meter sensors 322 in any of lines 302L, 302R, 304L, 304R, 306L, and 306R of FIG. 3, or alternate lines 442R, 442L, 440L, and 440R of FIG. 4, or the alternate lines feeding from valves 550L and 550R to lines 504L and 504R of FIG. 5, noting that alternate sensor locations and flow measurements are also available, depending on embodiment. The flow meter(s) send signals to this system controller which in turn may run through algorithms to determine when to terminate a first phase of the flow battery rebalancing, such as implemented in the methods described with regard to FIGS. 4 and 5. In one or more embodiments, the respective controller of the systems of FIGS. 3-5 may determine whether or when to rebalance the respective flow battery system based upon a predetermined expiration of time, volume of electrolyte transport, and/or other factors, such as determined imbalances in desired concentrations of the positive and/or negative electrolyte, including the above example desired concentrations discussed with regard to U.S. Pat. No. 6,764,789. The predetermined time and/or the volume of transported electrolyte may be determined through experimentation of the underlying flow battery system. For example, as discussed above, through experimentation it may have been determined that such a 30 day rebalancing schedule is sufficient to maintain the desired respective electrolyte concentration(s). Briefly, the indicated ‘preferred’ concentrations of U.S. Pat. No. 6,764,789 should not be interpreted as being similarly ‘preferred’ concentrations in one or more embodiments of the present invention, but rather, merely examples of concentrations and/or concentration ranges that could be used for discerning whether or when a flow battery system, according to one or more embodiments, should or could be rebalanced. Alternate concentrations and/or concentration ranges for determining whether or when to rebalance a flow battery system may also be available, such as depending on the type of aqueous electrolyte solution, e.g., alternate to a vanadium electrolyte solution, type and composition of membrane, flow rate, respective head pressures across such membranes, etc.

As noted above, when the methods described with regard to FIGS. 4 and 5 are used to rebalance the flow battery, an accidental mixing of electrolytes may occur inside the respective electrolyte storage tanks, e.g., ‘old electrolyte’ may become mixed with newly added new electrolyte'. Here, if new electrolyte is carefully added, without mixing, to the top of the storage tank; and old electrolyte is removed from the bottom of the storage tank; some mixing of old and new electrolyte may still occur at the interface between the old and new electrolyte. If one storage tank volume amount of electrolyte is removed and simultaneously added to the same storage tank, it can be assumed that approximately 10 to 20 percent of the old and new electrolyte would become mixed by the process. This accidental mixing of electrolytes may need to be taken into account when computing the efficiency of one or more embodiments, such as of embodiments described with regard to FIGS. 4 and 5. Here, as only an example, one estimate may be that 15-20% of the electrolyte ends up in the wrong tank after one cycle. This accidental mixing process may result in the methods described with regard to FIGS. 4 and 5 being less efficient than the method described with regard to FIG. 4. For example, see the example efficiencies described in the below Table 1. However, without such accidental mixing, the methods described with regard to FIGS. 4 and 5 may have the same values in all categories of Table 1 to those of the method described with regard to FIG. 3.

In an embodiment where the redox flow battery system is a VRFB system, the various rebalancing methods may all involve placing vanadium ions on ‘the wrong’, or opposite, side of the flow battery system through mixing and/or reversing the polarity of the flow battery system. Here, ‘the wrong’ side of the flow battery system means that vanadium ions that should originally be placed in the originally designated positive electrolyte storage tank are now placed in the originally designated negative storage tank, and vanadium ions that should originally be placed in the originally designated negative electrolyte storage tank are now placed in the originally designated positive storage tank. For example, V(2) and V(3) vanadium ions, which normally constitute the negative electrolyte, are mixed or otherwise placed on the positive side of the flow battery where a positive voltage is applied to boost their valence states to a mixture of V(5) and V(4) ions. Boosting vanadium ions across this range from V(2) to V(5) requires three successive oxidation reactions on the positive side of the flow battery as follows:

V²⁺→V³⁺+e⁻(+0.26 volts)

VO³⁺+H₂O→VO²⁺+2H⁺+e⁻(+0.333 volts)

VO²⁺+H₂O→VO₂⁺+2H⁺+e⁻(+1.00 volts)

The energy required to make these transitions is proportional to the voltage potential of the reaction. In one or more embodiments, on the negative side of the flow battery system a cascade of reduction reactions may take place which are the reverse of the above reactions with negative voltages instead of positive voltages. Knowing the relative distribution of vanadium ions at the beginning of a procedure and the desired distribution of vanadium ions at the end of the procedure, it is relatively straight forward to compute the relative energy required or provided by the procedure. Knowledge of these reactions was used to calculate the example energy requirements of the various flow battery rebalancing methods under consideration shown below in Table 1.

Thus, with regard to the below Table 1, calculations were performed to compute the relative energy efficiency of the various methods of rebalancing a vanadium redox flow battery. These calculations used simple linearlized extrapolations of the vanadium ion concentrations and assumed that three passes are used to charge the flow battery starting at its normal discharge state. However, more than three passes are required to rebalance a VRFB since the mixing of electrolytes places the VRFB further from the charged state then occurs during normal operation. The energy required (in arbitrary units) to balance a VRFB using each of the methods described above, required to bring the VRFB to its normal 80/20 charged state, is summarized in Table 1. below.

TABLE 1
Table 1. Effectiveness of Various VRFB Rebalancing Methods

| | Total Energy Required | Time Between | | Energy |
|---|---|---|---|---|
| | to Rebalance Battery | Re-Balancing | Average | Improvement |
| | (arbitrary | (arbitrary | Energy Required | Over Mixing |
| Operation | energy units) | time units) | (energy/time*100) | (percentage) |
| Charge Electrolyte from 20/80 | −76.8 | | | |
| to 80/20 SOC | | | | |
| Rebalance Electrolyte by Mixing | −135.7 | 100 | −135.70 | n/a |
| Polarity Switch, Method #1 | −194.6 | 200 | −97.30 | 28.3% |
| Polarity Switch, Method #2 | −176.93 | 170 * | −104.08 | 23.3% |
| Polarity Switch, Method #3 | −176.93 | 170 * | −104.08 | 23.3% |

* Assuming a 15% accidental mixing of electrolytes during rebalancing

Note in Table 1 that the energy requirements appear as negative numbers reflecting the fact that energy is being put into the VRFB during the charging process. Note in column two that Methods #2 and #3 (respectively representing the methods demonstrated by FIGS. 4 and 5) require less rebalancing energy than Method #1 (representing the method demonstrated by FIG. 3) due to accidental mixing of the two electrolytes, where some old positive electrolyte is left in the positive tank where it requires less energy to convert to fully charged positive electrolyte. The time (in arbitrary time units) simply expresses the fact that the VRFB can run for twice the time between rebalancing as explained earlier. Accidental mixing reduces the time between rebalancing somewhat. The next column expresses the average energy of the various rebalancing methods over time (total energy required divided by time between flow battery rebalancing procedures). The last column of Table 1 list the percentage advantage of the three polarity switching methods over the standard electrolyte mixing method of FIG. 2. The 28% and 23% efficiency advantages give polarity switching a clear advantage over the conventional mixing method.

In the above discussion the flow battery was assumed to be in an 20/80 state of discharge when the rebalancing is initiated. Instead the rebalancing could take place when the flow battery is in a fully charged condition having a 80/20 SOC. The results of doing this are shown in Table 2 below.

TABLE 2
Table 2. Effectiveness of Various VRFB Rebalancing Methods Starting with a 80/20 SOC.

| | Total Energy Required | Time Between | | Energy |
|---|---|---|---|---|
| | to Rebalance Battery | Re-Balancing | Average | Improvement |
| | (arbitrary | (arbitrary | Energy Required | Over Mixing |
| Operation | energy units) | time units) | (energy/time*100) | (percentage) |
| Charge Electrolyte from 20/80 | −76.8 | | | |
| to 80/20 SOC | | | | |
| Rebalance Electrolyte by Mixing | −135.7 | 100 | −135.70 | n/a |
| Polarity Switch, Method #1 | −271.4 | 200 | −135.70 | 0.0% |
| Polarity Switch, Method #2 | −230.69 | 170 * | −135.70 | 0.0% |
| Polarity Switch, Method #3 | −230.69 | 170 * | −135.70 | 0.0% |

* Assuming a 15% accidental mixing of electrolytes during rebalancing

Table 2 shows that when the flow battery starts out fully charged and is then rebalanced; example methods demonstrated by FIGS. 3-5 may yield the same high energy requirements.

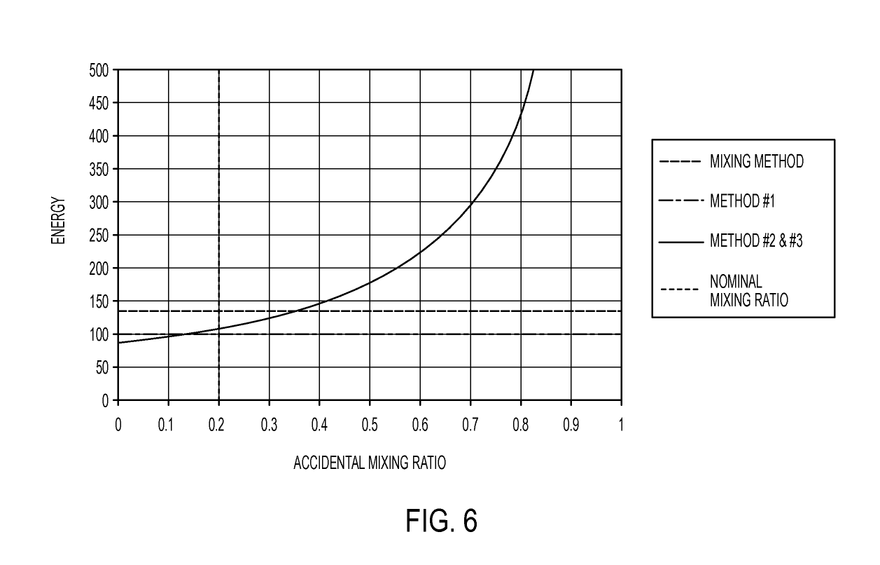

As only an example, FIG. 6 illustrates plots of example energy requirements of various example rebalancing methods against the ratio of accidental mixing, according to one or more embodiments. As noted above, though accidental mixing may only take place in the methods demonstrated by FIGS. 4 and 5, the method demonstrated by FIG. 3 and the conventional mixing method of FIG. 2 are also plotted to serve as reference lines. As shown in FIG. 6, if accidental mixing is kept low, e.g., below 30%, the methods demonstrated by FIGS. 4 and 5 may still be better than the conventional mixing method of FIG. 2. In addition, at an accidental mixing level of around 10% or less, the methods demonstrated by FIGS. 4 and 5 are about equivalent efficiency wise to the electrical polarity switching of the method demonstrated by FIG. 3.

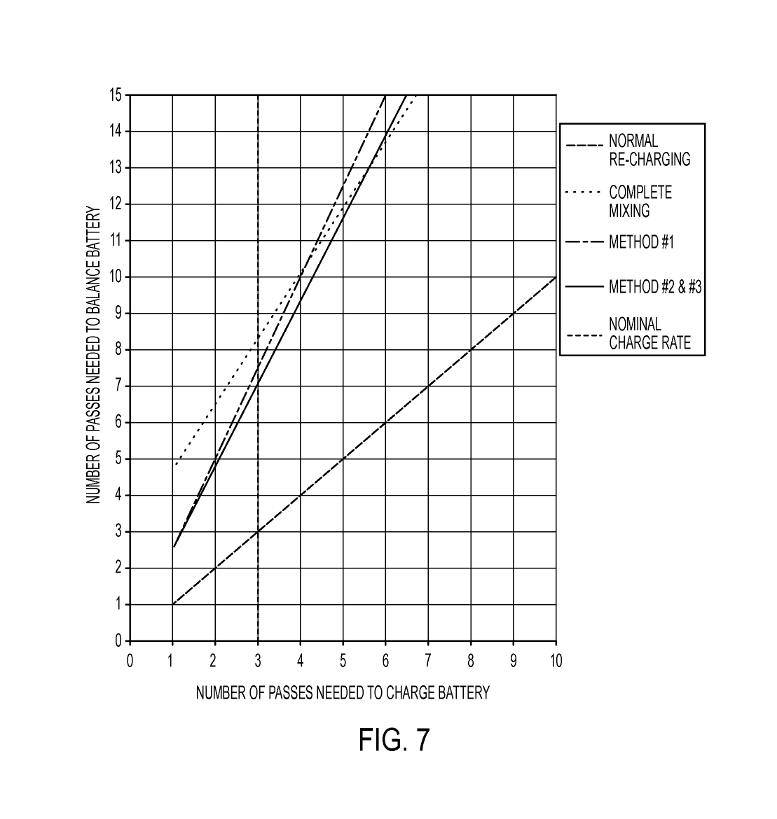

FIG. 7 illustrates plots of a number of passes implemented to charge a flow battery as a function of the number of passes to normally charge a flow battery from 20/80 to 80/20 SOC, according to one or more embodiments. As illustrated in FIG. 7, in an example, if three passes are normally needed to recharge the flow battery, then the conventional complete mixing of the flow battery according to the conventional method of FIG. 2 would require 8.3 passes to reach the 80/20 SOC. Rather, as only examples, according to one or more embodiments a polarity switching according to the method described with regard to FIG. 3 may only require 7.6 passes, and methods described with regard to FIGS. 4 and 5 may only require 6.9 passes. Thus, if for example, it requires 4 hours to pump all available electrolyte through a battery stack one time, then at the 3-pass charging rate it would normally take 12 hours to recharge the flow battery, and it may take about 30.4 hours to balance the flow battery using the method described with regard to FIG. 3, 27.6 hours using the methods described with FIGS. 4 and 5, and 33.2 hours to balance a flow battery using a conventional mixing method. Considering also that the polarity switching methods, according to one or more embodiments, may only have to be performed half as often as the conventional mixing method described with regard to FIG. 2, there are substantial benefits of using one or more embodiments described herein over the conventional mixing process. Further, averaged over time, the conventional mixing method of FIG. 2 causes the flow battery to be out-of-service twice as long as one or more example polarity switching methods according to differing embodiments of the present invention. Accordingly, such polarity switching methods according to differing embodiments of the present invention also offer a considerable economic advantage over conventional mixing approaches.

In addition to requiring less energy and less down time, polarity switching methods according to differing embodiments of the present invention, such as polarity switching methods of rebalancing a vanadium redox flow battery, more easily lend themselves to automation. Accordingly, one or more embodiments further include automatically rebalancing the flow battery systems. Depending on embodiment, such automated rebalancing is performed by a controller, such as the controller 360 shown in FIG. 3. As only an example, and depending on embodiment, all three-port valves could be controlled by such a controller and the DPDT switches in the rectifier/inverter electronics could be likewise operate under automated control of the controller. For example, in one or more embodiments, the controller may implement the method described with regard to FIG. 3 with merely an all-electronic switching of the polarity. Further, in one or more embodiments, the controller may implement the method described with regard to FIG. 4 with both an electronic switching and a controlling operation of the described valves. Similarly, in one or more embodiments, the controller may implement the method described with regard to FIG. 5 with only a controlling operation of the described fluid control valves. Still further, in one or more embodiments, the controller may determine what elements of such battery stack polarity switch, e.g., the example DPDT switch (FIGS. 3 and 4), and/or such valve controllers before (FIG. 5) or after (FIG. 4) the battery stack, are included in the underlying flow battery system and control any to implement one or more of the methods described with regard to FIGS. 3-5.

As noted above, because of the reverse operation of the membranes of the battery cells of the battery stack when the polarity of the battery stack is reversed, e.g., by reversal of the power source terminal connections, the above described methods with regard to the descripts of FIGS. 3 and 4 may be restricted to designs, e.g., VRFB designs, that use a neutral or reversible membrane. Polarity switching methods may also work best when the electrolyte is sprayed or dripped into the top of the respective storage tanks when being returned from the battery stack, so that there is little mixing of the electrolyte. These methods also help to reduce shunt currents within a flow battery. On the other hand, the conventional mixing method of FIG. 2 works best if mixing equipment is provided to enhance the mixing of positive and negative electrolyte during the rebalancing process; which would increase the cost of the flow battery system.

As noted above, the conventional method of re-mixing of all electrolyte ingredients requires the flow battery to be ‘off’ or idle (not charging) while mixing electrolytes and is not very efficient. Conversely, as shown above, one or more methods of the present invention are more efficient than the conventional re-mixing approach and can be implemented by the flow battery is on, or charging. For example, as noted above, in an example embodiment according to the method described with regard to FIG. 3 there is a 28.3% increase in improvement over the conventional mixing approach, and in example embodiments according to the methods described with regard to FIGS. 4 and 5 there is a 23.3% increase in improvement over the conventional mixing approach. In addition, in an example embodiment according to the method described with regard to FIG. 3 the number of passes it takes to reach 80/20 SOC of the electrolyte is less than the conventional mixing approach, and the example embodiments according to the methods described with regard to FIGS. 4-5 require less number of passes to reach 80/30 SOC than the example method described with regard to FIG. 3

In addition, depending on implementation and needs, the configuration and method described with regard to FIG. 5 may have the most over-all advantages. However, the configurations and methods described with regard to FIGS. 3 and 4 also have unique advantages that may be more advantageous in particular circumstances. For example, if a primary consideration is over-all energy efficiency, then the configuration and method described with regard to FIG. 3 may be preferred over the configurations and methods described with regard to FIGS. 4 and 5. Similarly, if the half-cell membranes have no polarity preference, then it may be desirable to use the configurations and methods described with regard to FIGS. 3 and 4, where the half-cell membrane can be periodically reversed to flush out vanadium reactants that may accumulate on one side of the membrane. Still further, it may be advantageous to occasionally store electrolyte of the opposite polarity in opposite electrolyte storage tanks to prevent the accumulation of deposits on the walls of the storage tanks. In this case, the configuration and method of FIG. 2 may be more desired, because this approach involves polarity reversal of the storage tanks would be of advantage.

FIGS. 3 through 5 depict various configurations of redox flow battery systems in schematic form. Each flow battery component is given a standard pictorial representation and arranged in accordance with the arrangement and methods of embodiments of this invention ranging from the simple to the more complex. The systems described here are described as being symmetric between the two electrolytic sides of the flow battery, but embodiments are not limited to the same. For drawings only show some elements of the flow battery embodiments of the present invention, sufficient for understanding. Embodiments further include check valves, safety and pressure relief valves, heat exchangers, and the like.

The snorkel, pictured as 310L and 310R in FIG. 3, as only an example, is a device made up of several simpler components and having the purpose of allowing pressure inside the tank to be equalized with the outside atmosphere without allowing mixing of the two gases. Each of the embodiments herein may include such snorkels. The tops of the tanks may be usually filled with an inert gas 135 (shown in FIG. 1) or 335 (shown in FIG. 3), such as nitrogen or argon, to prevent oxidation of the electrolyte. The snorkels may include bladders, one-way-valves, gas regulators, membranes, solenoids valves, screens, and other commercial components mounted in a housing. If the snorkel is exposed to the outside environment the housing may be built to prevent snow, ice, and rain; animals, birds and tree seeds; and other environmental conditions from entering its mechanism, or corroding its components.

The electrolyte storage tanks may usually be mounted in some sort of tray or reservoir, shown as 111L and 111R (shown in the FIGS. 1) and 311L and 311R (shown in FIG. 3), to prevent any tank leakage or spills from getting into the environment. The tray or reservoir may be at ground level or below ground level. Depending on embodiment, the storage tanks may be large storage tanks resting on the ground level with funnel-like bottoms leading to an exit line emerging from the lowest point of the tank, as only an example. Depending on embodiment, the exit lines may be equipped with a filter to remove any sediment that may accumulate at the bottom of the tanks.

Currently, most VRFBs have the battery stacks elevated above the tops of the storage tanks. This allows for gravity return of electrolyte emerging from the top of the battery stack, i.e., so electrolyte can flow by gravity back into their respective storage tanks without the need of further pumping. In FIGS. 3-5, the electrical poles of the battery stack are shown at the tops of the battery stack. Further, a very simplified circuit diagram is shown above each battery stack in the drawings to illustrate the current flows into the battery during charging. Here, embodiments should not be limited to such simplified demonstrations of the arrangements of the battery stack, poles, or circuit diagrams connected to the same. Rather, the battery stacks may have different configurations, such as wherein the inlet of the battery stacks may be on a lateral, top, or bottom side, just as the outlet may also be on a lateral, top, or bottom side. The inlet and outlet of the battery stacks may be configured on a same side, adjacent sides, or opposite side, as only examples, noting that battery stacks can have many different physical arrangements with multiple sides. Differing configured battery stacks may also be included in the same flow battery system. Still further, in differing embodiments, it may be desired to have different flow rates of positive electrolyte through a positive side half-cell compared to negative electrolytes through the corresponding negative side half-cell, and this may be implemented by the controller differently controlling pumping speeds of the illustrated feed pumps, as only an example.

In addition, depending on embodiment, the flow battery may utilize rectifiers to convert alternating current (AC) coming from a grid to direct current (DC) power, that may be required by the batteries. Inverters may be used to convert the DC current stored in the flow battery to AC power that is then output to the grid or other use. Depending on embodiment, the included electronics may also include transformers or other means to boost the voltage or draw down the voltage between the flow battery and the user/supplier of power. These several functions may be performed by a single complex bank of electronic components, as only an example.

The present invention should not be considered limited to the specific examples described herein, but rather should be understood to cover all aspects of the invention. Various modifications, equivalent processes, as well as numerous structures and device substitutions may be applicable will be readily apparent to those of skill in the art. Those skilled in the art will understand that various additions, changes, and re-configurations may be made without departing from the scope of the invention, which is not to be considered limited to what is described in the specification.

In the above descriptions, rebalancing of the flow battery may be usually initiated when the flow battery is in a discharged state, or more commonly, when the flow battery is in a 20/80 charge/discharge state, but embodiments are not limited to the same. Methods of this invention are also applicable when the flow battery is in any initial state of charge, from fully discharged to fully charged; though the energy advantages may be lost when the methods are applied to a charged flow battery.

In one or more embodiments, methods of rebalancing a flow battery, e.g., a VRFB, were illustrated using a two tank electrolyte storage system, wherein the tanks generally always contain a mixture of charged and depleted electrolyte. Alternative embodiments include four tank flow battery systems, e.g., VRFB systems, whereby charged and discharged electrolyte is stored in separate tanks. One or more embodiments may also be applied to very large multiple tank flow battery systems, e.g., VRFB systems, with suitable additions to the plumbing and control systems. Still further, one or more embodiment include to series or parallel connected arrangements of storage tanks. Likewise, one or more embodiment include single as well as multiple battery stacks which may be connected in series or in parallel.

One or more embodiments further include gravity feed flow battery systems, e.g., VRFB systems, where gravity feed is used instead of feed pumps, such as pumps 303L and 303R of FIG. 3, as only an example, whereby the storage tanks are on the same level, or above the battery stacks. The plumbing and flow paths of the flow battery system, e.g., VRFB system, may include heat exchangers, one-way-valves, clean-out ports, safety release vents, filters, sensors, and other devices without limiting the claims and coverage of this invention. The three-port valves described herein may be hydraulic, pneumatic, manual, solenoid, motor controlled, or of whatever other type serves the described operations. One or more embodiment include batteries having cation, or anion, or neutral membranes with suitable corrections to the polarity, direction of electrolyte flow, control algorithms, and other adjustments. In one or more embodiments, methods described herein may by applied to single metal flow batteries for other then to correct water transfer of electrolyte imbalance. In one or more embodiments, methods described herein may also be applied to a redox flow battery to “refresh” the electrolytes, or reference and filter the electrolytes, and the like. As only an example, corresponding embodiments may also include filter equipment in any of the described lines, as only an example.

One or more embodiment include apply to an all vanadium flow battery (vanadium/vanadium battery), whereby the positive electrolyte uses a VO₂⁺/VO²⁺ couple and the negative electrolyte uses a V³⁺/V²⁺ couple. One or more embodiment also apply to any other redox flow battery wherein the positive and negative electrolytes contain the same elemental reactants such that they can be mixed together and switched in polarity and still perform as a flow battery, as required. For example, one possible single-element flow battery combination uses a Cr⁵⁺/Cr⁴⁺ couple on the positive side and a Cr³⁺/Cr²⁺ couple on the negative side. Accordingly, one or more embodiment apply to any redox flow battery using vanadium/vanadium, chrome/chrome, or any other single element reactant combinations.

One or more embodiments having such various elements shown in the drawings and described herein may be reconfigured into other arrangements and designs within the scope of this invention. Depending on embodiment, the concepts of this invention apply to single element flow batteries of any workable size, scale, or configuration, as only an example.

Depending on embodiment, apparatuses, systems, and units descriptions herein may respectively include one or more hardware devices or hardware processing elements. For example, in one or more embodiments, any described apparatus, system, and unit, as well as any claimed controller, may further include one or more desirable memories, and any desired hardware input/output transmission devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented by at least one processing device, such as a processor or computer, or the controller 360 and at least one processing device 361 of FIG. 3. Further to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device. The processing element may be a specially designed computing device to implement one or more of the embodiments described herein.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

1. A flow battery system, comprising:
a feed system configured to at least feed positive electrolyte transported from a first storage tank, storing the positive electrolyte, to a positive inlet of a battery stack configured for transport to a first half cell of a battery cell of the battery stack, and configured to feed negative electrolyte transported from a second storage tank, storing the negative electrolyte, to a negative inlet of the battery stack configured for transport to a second half cell of the battery cell;
a return system configured to at least return charged electrolyte transported from the first half cell to the first storage tank and to return charged electrolyte transported from the second half cell to the second storage tank; and
a controller to control a polarity switching of the flow battery system to selectively control at least one of the feed system and the return system, so positive electrolyte, from the first storage tank, transported in the feed system to the battery stack is applied a negative charge by the battery stack and then returned by the return system to the second storage tank, and so negative electrolyte, from the second storage tank, transported in the feed system to the battery stack is applied a positive charge by the battery stack and then returned by the return system to the first storage tank.

2. The flow battery system of claim 1, wherein the controller is at least one of a valve controller in feed system and a valve controller in the return system, and the selective control to perform the polarity switching is performed based on a determined ion reactant imbalance between electrolytes stored in the first storage tank and the second storage tank.

3. The flow battery system of claim 2, wherein the controller further comprises a controller unit, including one or more processing devices, in communication with one or more of the valve controller in feed system, the valve controller in the return system, wherein the controller unit determines when to perform the polarity switching of the flow battery system based upon the determined ion reactant imbalance.

4. The flow battery system of claim 3, further comprising one or more state of charge (SOC) sensors configured to determine an SOC of the positive and/or negative electrolytes in the flow battery system, and wherein the controller uses the determined SOC to determine when to reverse the controlled polarity switching of the flow battery system.

5. The flow battery system of claim 3, further comprising one or more flow sensors configured to determine an amount of flow of electrolytes in the flow battery system after the polarity switching occurs to determine when to reverse the controlled polarity switching of the flow battery system.

6. The flow battery system of claim 1, wherein the controller determines when to perform the polarity switching of the flow battery system based upon a determination of a sufficiently discharged state of an electrolyte in the flow battery system.

7. The flow battery system of claim 6, wherein the sufficiently discharged state of electrolyte is a 20/80 state of charge (SOC) of the positive or negative electrolyte stored in the first or second storage tanks.

8. The flow battery system of claim 1, wherein the controlling of the polarity switching of the flow battery system includes at least one of controlling the feed system to feed the positive electrolyte transported from the first storage tank to the negative inlet of the battery stack and to feed the negative electrolyte transported from the second storage tank to the positive inlet of the battery stack and controlling the return system to return the charged electrolyte transported from the first half cell to the second storage tank and to return the charged electrolyte from the second half cell to the first storage tank.

9. The flow battery system of claim 8, wherein the controlling of the return system further comprises controlling a battery lead system to switch a polarity of first and second poles of the battery stack so the first half cell applies a negative charge and the second half cell applies a positive charge.

10. The flow battery system of claim 1, further comprising:
a battery lead system including a switch for switching polarities of first and second poles of the battery stack; and
the battery stack including the battery cell, having the first half cell and the second half cell, configured so electrolyte transported through the first half cell is charged by the first pole and electrolyte transported through the second half cell is charged based on the second pole, the first pole and the second pole being opposite poles.

11. The flow battery system of claim 10, further comprising the first storage tank storing the positive electrolyte and the second storage tank storing the negative electrolyte.

12. The flow battery system of claim 1, wherein the controller controls the flow battery system to control the polarity switching of the flow battery system by controlling the polarity of first and second poles of the battery stack, to change from a first set polarity, where the first half cell applies the positive charge and the second half cell applies the negative charge, to a second set polarity, where the first half cell applies the negative charge and the second half cell applies the positive charge, upon a determined ion reactant imbalance between electrolytes stored in the first storage tank and the second storage tank.

13. The flow battery system of claim 12, wherein the ion reactant imbalance determination is based upon a determined excess in volume of electrolyte in the first storage tank and/or the second storage tank.

14. The flow battery system of claim 1, wherein the controlling of the polarity switching of the flow battery system includes controlling the return system, with the return system being configured so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed.

15. The flow battery system of claim 14, wherein the controller controls the polarity switching of the flow battery system to selectively control the return system and a battery lead system for the battery stack, wherein the controlling of the battery lead system includes controlling a polarity of first and second poles of the battery stack, to change from a first set polarity, where the first half cell applies the positive charge and the second half cell applies the negative charge, to a second set polarity, where the first half cell applies the negative charge and the second half cell applies the positive charge.

16. The flow battery system of claim 15, wherein the controller performs the polarity switching of the flow battery system when an ion reactant imbalance is determined between electrolytes stored in the first storage tank and the second storage tank.

17. The flow battery system of claim 15, wherein, upon a determined stopping point of the polarity switching, the controller controls the flow battery system to stop the polarity switching and be set to a normal mode, which includes controlling a switching of the polarity of the first and second poles so the first half cell applies the positive charge and the second half cell applies the negative charge and controlling the return system to return the charged electrolyte transported from the first half cell to the first storage tank and to return the charged electrolyte from the second half cell to the second storage tank.

18. The flow battery system of claim 17, wherein the determined stopping point is determined to be before a time when plural cycles of a volume of electrolyte of one of the first or second storage tanks has flowed through one or more battery stacks of the flow battery system.

19. The flow battery system of claim 15, wherein the first half cell and the second half cell are in fluid separation in the battery cell by a neutral or reversible exchange membrane, distinct from a cation exchange membrane and an anion exchange membrane.

20. The flow battery system of claim 1, wherein the controlling of the polarity switching of the flow battery system includes controlling the feed system, with the feed system being configured so as to feed the positive electrolyte transported from the first storage tank to the negative inlet of the battery stack and to feed the negative electrolyte transported from the second storage tank to the positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed.

21. The flow battery system of claim 20, wherein the controller performs the polarity switching of the flow battery system when an ion reactant imbalance is determined between electrolytes stored in the first storage tank and the second storage tank.

22. The flow battery system of claim 20, wherein, upon a determined stopping point of the polarity switching of the flow battery system, the controller controls the flow battery system to stop the polarity switching and be set to a normal mode, which includes controlling the feed system to feed the stored positive electrolyte transported from the first storage tank to the positive inlet of the battery stack and to feed the stored negative electrolyte transported from the second storage tank to the negative inlet of the battery stack.

23. The flow battery system of claim 22, wherein the determined stopping point is determined to occur after at time when at least plural cycles of a volume of electrolyte of one of the first or second storage tanks has flowed through battery stacks of the flow battery system.

24. The flow battery system of claim 20, wherein the first half cell and the second half cell are in fluid separation by a cation exchange membrane or an anion exchange membrane.

25. The flow battery system of claim 1, wherein the electrolytes include positive and negative electrolytes that respectively are single elemental reactants.

26. The flow battery system of claim 25, wherein the positive electrolyte is a VO₂⁺/VO²⁺ couple and the negative electrolyte is a V³⁺/V²⁺ couple.

27. A flow battery system, comprising:
a battery stack including a battery cell, including a first half cell and a second half cell, configured so electrolyte transported through the first half cell is charged based on a first pole of the battery stack and electrolyte transported through the second half cell is charged based on a second pole of the battery stack, the first pole and the second pole being opposite poles;
a first storage tank storing positive electrolyte;
a second storage tank storing negative electrolyte;
a feed system configured to at least feed the positive electrolyte transported from the first storage tank to the battery stack and to feed the negative electrolyte transported from the second storage tank to the battery stack;
a return system configured to at least return charged electrolyte transported from the first half cell to the first storage tank and to return charged electrolyte transported from the second half cell to the second storage tank; and
a controller to control a polarity switching of the flow battery system to rebalance electrolyte ion reactant concentrations of the positive electrolyte stored in the first storage tank and/or negative electrolyte stored in the second storage tank, by positive electrolyte, from the first storage tank, transported in the feed system to the battery stack being applied a negative charge by the battery stack and then being returned by the return system to the second storage tank, and by negative electrolyte, from the second storage tank, transported in the feed system to the battery stack being applied a positive charge by the battery stack and then being returned by the return system to the first storage tank.

28. The flow battery system of claim 27, wherein the electrolytes include positive and negative electrolytes that respectively are single elemental reactants.

29. The flow battery system of claim 28, wherein the positive electrolyte is a VO₂⁺/VO²⁺ couple and the negative electrolyte is a V³⁺/V²⁺ couple.

30. The flow battery system of claim 27, wherein, in the controlling of the polarity switching of the flow battery system, the controller further controls a setting of a polarity of the battery stack, between a first set polarity where the first pole is controlled to be a positive pole and the second pole is controlled to be a negative pole and a second set polarity where the first pole is controlled to be the negative pole and the second pole is controlled to be the positive pole, such that the polarity switching of the flow battery system is performed by changing the polarity of the battery stack from the first set polarity to the second set polarity, so that the positive electrolyte fed by the feed system from the first storage tank to the first half cell is negatively charged and the negative electrolyte fed by the feed system from the second storage tank to the second half cell is positively charged.

31. The flow battery system of claim 30, wherein, in the controlling of the polarity switching of the flow battery system, the return system is configured so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed.

32. The flow battery system of claim 27, wherein, in the controlling of the polarity switching of the flow battery system, the feed system is configured so as to feed the positive electrolyte transported from the first storage tank to a negative inlet of the battery stack and to feed the negative electrolyte transported from the second storage tank to a positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed.

33. A flow battery system, comprising:
a controller to control a polarity switching of the flow battery system to selectively control at least one of a feed system and a return system for a battery stack of the flow battery system, to rebalance electrolyte ion reactant concentrations of positive electrolyte stored in a first storage tank and/or negative electrolyte stored in a second storage tank, so the positive electrolyte, from the first storage tank, transported in the feed system to the battery stack is applied a negative charge by the battery stack and then returned by the return system to the second storage tank, and so the negative electrolyte, from the second storage tank, transported in the feed system to the battery stack is applied a positive charge by the battery stack and then returned by the return system to the first storage tank, to rebalance the electrolyte ion reactant concentrations,
such that the feed system is configured to at least feed the positive electrolyte transported from the first storage tank to a positive inlet of the battery stack configured for transport to a first half cell of a battery cell of the battery stack, and configured to feed the negative electrolyte transported from the second storage tank to a negative inlet of the battery stack configured for transport to a second half cell of the battery cell, and such that the return system is configured to at least return charged electrolyte transported from the first half cell to the first storage tank and to return charged electrolyte transported from the second half cell to the second storage tank.

34. A method for controlling a flow battery system, the method comprising:
feeding positive electrolyte transported from a first storage tank, storing the positive electrolyte, to a positive inlet of a battery stack configured for transport to a first half cell of a battery cell of the battery stack, and feeding negative electrolyte transported from a second storage tank, storing the negative electrolyte, to a negative inlet of the battery stack configured for transport to a second half cell of the battery cell;
returning charged electrolyte transported from the first half cell to the first storage tank and returning charged electrolyte transported from the second half cell to the second storage tank; and
selectively controlling a polarity switching of the flow battery system by controlling at least one of a changing of the feeding of electrolyte to the battery stack and changing of the returning of charged electrolyte from the battery stack to the first and second storage tanks, so positive electrolyte, from the first storage tank, transported in the feed system to the battery stack is applied a negative charge by the battery stack and then returned by the return system to the second storage tank, and so negative electrolyte, from the second storage tank, transported in the feed system to the battery stack is applied a positive charge by the battery stack and then returned by the return system to the first storage tank.

35. The method of claim 34, wherein the polarity switching of the flow battery system is performed based on a determined ion reactant imbalance between electrolytes stored in the first storage tank and the second storage tank.

36. The method of claim 34, wherein the selective controlling of the polarity switching includes selectively controlling one of a valve controller in a feed system of the flow battery system to perform the changing of the feeding of electrolyte to the battery stack and a valve controller in a return system of the flow battery system to perform the changing of the returning of charged electrolyte from the battery stack to the first and second storage tanks, based on a determined ion reactant imbalance between electrolytes stored in the first storage tank and the second storage tank.

37. The method of claim 36, further comprising determining when to perform the polarity switching of the flow battery system based upon the determined ion reactant imbalance between electrolytes in the first storage tank and second storage tank.

38. The method of claim 37, further comprising monitoring a state of charge (SOC) of the positive and/or negative electrolytes in the flow battery system, and determining when to reverse the controlled polarity switching of the flow battery system based on the monitored SOC.

39. The method of claim 37, further comprising monitoring an amount of flow of electrolytes in the flow battery system after the polarity switching to determine when to reverse the controlled polarity switching of the flow battery system.

40. The method of claim 34, further comprising determining when to perform the polarity switching of the flow battery system based upon a determination of a sufficiently discharged state of an electrolyte in the flow battery system.

41. The method of claim 40, wherein the sufficiently discharged state of electrolyte is a 20/80 state of charge (SOC) of the positive or negative electrolyte stored in the first or second storage tanks.

42. The method of claim 34, wherein the battery stack includes the battery cell, having the first half cell and the second half cell, configured so electrolyte transported through the first half cell is charged by a first pole of the battery stack and electrolyte transported through the second half cell is charged based on a second pole of the battery stack, the first pole and the second pole being opposite poles.

43. The method of claim 42, wherein the controlling of the polarity switching includes controlling a changing of the polarity of the battery stack, by controlling a polarity of the first and second poles of the battery stack, to change from a first set polarity, where the first half cell applies the positive charge and the second half cell applies the negative charge, to a second set polarity, where the first half cell applies the negative charge and the second half cell applies the positive charge, upon a determined ion reactant imbalance between electrolytes stored in the first storage tank and the second storage tank.

44. The method of claim 43, further comprising monitoring volumes of electrolyte stored in the first and/or second storage tanks and determining the ion reactant imbalance based upon a determined excess in the monitored volume of electrolyte in the first or second storage tanks.

45. The method of claim 34, wherein the controlling of the polarity switching includes controlling the changing of the returning of charged electrolyte from the battery stack to the first and second storage tanks, so as to return the charged electrolyte transported from the first half cell to the second storage tank and return the charged electrolyte transported from the second half cell to the first storage tank when the polarity switch of the flow battery system is performed, and so as to return the charged electrolyte transported from the first half cell to the first storage tank and return the charged electrolyte transported from the second half cell to the second storage tank when the polarity switch of the flow battery system is not performed.

46. The method of claim 45, wherein the controlling of the polarity switching further includes a changing of a polarity of the battery stack, comprising controlling a polarity of first and second poles of the battery stack to change from a first set polarity, where the first half cell applies the positive charge and the second half cell applies the negative charge, to a second set polarity, where the first half cell applies the negative charge and the second half cell applies the positive charge, when the polarity switch of the flow battery system is performed and to subsequently switch back to the first set polarity when the polarity switching is stopped.

47. The method of claim 46, further comprising determining to stop the polarity switching before a time when plural cycles of a volume of electrolyte of one of the first or second storage tanks has flowed through one or more battery stacks of the flow battery system.

48. The method of claim 46, wherein the first half cell and the second half cell are in fluid separation in the battery cell by a neutral or reversible exchange membrane, distinct from a cation exchange membrane and an anion exchange membrane.

49. The method of claim 34, wherein the controlling of the polarity switching includes controlling the changing of the feeding of electrolyte to the battery stack, so as to feed the positive electrolyte transported from the first storage tank to the negative inlet of the battery stack and to feed the negative electrolyte transported from the second storage tank to the positive inlet of the battery stack when the polarity switch of the flow battery system is performed, and so as to feed the positive electrolyte transported from the first storage tank to the positive inlet of the battery stack and to feed the negative electrolyte transported from the second storage tank to the negative inlet of the battery stack when the polarity switch of the flow battery system is not performed.

50. The method of claim 49, wherein, upon a determined stopping point of the polarity switching of the flow battery system, the controlling of the polarity switching controls the flow battery system to stop the polarity switching and the flow battery system to be set to a normal mode, which includes controlling the feed system to feed the stored positive electrolyte transported from the first storage tank to the positive inlet of the battery stack and to feed the stored negative electrolyte transported from the second storage tank to the negative inlet of the battery stack.

51. The method of claim 50, further comprising determining the stopping point to occur after a time when at least plural cycles of a volume of electrolyte of one of the first or second storage tanks has flowed through battery stacks of the flow battery system.

52. The method of claim 49, wherein the first half cell and the second half cell are in fluid separation by a cation exchange membrane or an anion exchange membrane.

53. The method of claim 34, wherein the electrolytes include positive and negative electrolytes that respectively are single elemental reactants.

54. The method of claim 53, wherein the positive electrolyte is a VO₂⁺/VO²⁺ couple and the negative electrolyte is a V³⁺/V²⁺ couple.
